(19) United States
(12) Patent Application Publication
(10) Pub. No.: US 2012/0107624 A1
(43) Pub. Date: May 3, 2012

(54) MODIFICATION OF LAYERED SILICATES FOR LUMINESCENCE ACTIVATION

(75) Inventors: Peter Klauth, Mönchengladbach (DE); Manfred Rietz, Erkelenz (DE); Jürgen Büddefeld, Duisburg (DE); Ulrich Kynast, Steinfurt (DE); Marina Lezhnina, Steinfurt (DE)

(73) Assignee: INBIO PROF. JURGEN BUDDEFELD DR. PETER KLAUTH PROF. MANFRED RIETZ, Duisburg (DE)

(21) Appl. No.: 13/263,414

(22) PCT Filed: Mar. 17, 2010
(86) PCT No.: PCT/EP2010/001663

§ 371 Date: Oct. 7, 2011

(30) Foreign Application Priority Data
Apr. 7, 2009 (DE) 10 2009 016 395.6
Jun. 12, 2009 (DE) 10 2009 024 673.8

(51) Int. Cl. B32B 9/00; C09K 11/06

(52) U.S. Cl. 428/446; 264/21

(57) ABSTRACT

The invention relates to a method for producing a luminescent layered silicate composite. The method according to the invention is characterized in that at least one luminescent dye, in particular fluorescent dye, on the basis of at least one complex, essentially a chelate complex, of at least one element of the rare earth elements (“rare earth complex”) is introduced between and/or stored in at least two layers of at least one layered silicate (“layered silicate layers”) respectively or that at least one luminescent dye, in particular fluorescent dye, on the basis of at least one complex, essentially a chelate complex, of at least one element of the rare earth elements (“rare earth complex”) is combined with a layered silicate to form a composite. The luminescent layered silicate composite according to the invention can be used for marking objects, for example plastic-based objects, or in the field of bioanalysis.

### CROSS-REFERENCES TO RELATED APPLICATIONS

This application is a National Stage filing of International Application PCT/EP 2010/001663, filed Mar. 17, 2010, entitled “MODIFICATION OF LAYERED SILICATES FOR LUMINESCENCE ACTIVATION” claiming priority to German Applications No. DE 10 2009 016 395.6, filed Apr. 7, 2009 and DE 10 2009 024 673.8, filed Jun. 12, 2009. The subject application claims priority to PCT/EP 2009/005182, and to German Applications No. DE 10 2009 016 395.6 and No. DE 10 2009 024 673.8 and incorporates all by reference herein, in their entirety.

### BACKGROUND OF THE INVENTION

The present invention relates to the field of luminescent dyes or dye complexes based on rare-earth elements, which can be used in particular for coloring or marking objects, for example based on glass or plastics, but also for the marking (labeling) and/or identification of biological systems, such as biological cells, and biomolecules, such as in particular proteins, peptides, antibodies and nucleic acids.

The present invention relates to the luminescence activation of layered silicates with complexes of the rare earths, wherein the layered silicates activated in this way can find application for example in and/or on polymers, such as biopolymers, in and/or on fibers or textiles, for coating various kinds of surfaces and as carrier or substrate for biochemically relevant compounds.

In particular the present invention relates to a method of production of at least one luminescent, dye based on at least one rare-earth element containing luminescent layered silicate composite.

The present invention further relates to a luminescent layered silicate composite, which is obtainable by the method according to the invention.

Moreover, the present invention relates to a luminescent layered silicate composite as such, which has at least one luminescent dye based on a complex of at least one rare-earth element.

Furthermore, the present invention relates to a solution or dispersion, which contains at least one luminescent layered silicate composite according to the invention.

Moreover, the present invention relates to the use of the luminescent layered silicate composite according to the invention for staining or labeling or identifying a target structure or a target molecule.

The present invention further relates to the use of the luminescent layered silicate composite according to the invention for the luminescent marking or identification of at least one target structure or target molecule.

Furthermore, the present invention relates to a method for labeling or identifying at least one target structure or target molecule using the layered silicate composite according to the invention.

The present invention also relates to a layered silicate composite/target structure conjugate or a layered silicate composite/target molecule conjugate, which can be obtained by contacting or by reacting at least one target structure or target molecule with the layered silicate composite according to the invention.

Finally the present invention relates to a layered silicate composite/target structure mixture or a layered silicate composite/target molecule mixture, which is obtainable by contacting or introduction or incorporation of the layered silicate composite according to the invention into a mass containing the target structure or the target molecule.

Photoluminescent systems as such are known in the prior art, and for example are incorporated or mixed with products for purposes of product marking or for product identification and for purposes of decoration. The products modified in this way are for example plastics. In this connection, often pigments, in particular based on inorganic coloring and luminous pigments, and sometimes also organic luminescent dyes, are used in the prior art. A disadvantage with the methods of marking in the prior art is that for example incorporated pigments or pigment-based markers basically cause scattering, so that transparent solutions, layers or bodies cannot be prepared in this way.

Moreover, regarding the use of luminescent, dyes known from the prior art, based on complexes of the rare earths and/or organic dyes, these have the disadvantage that often only chemically or photochemically labile complexes are present, which eventually disintegrate and therefore the luminescent marking for example of a product, marked therewith is also lost. Furthermore, complexes of the rare earths have a nonoptimal solubility, which is generally restricted to a narrowly defined polarity range, requiring the use of special solvents or solubilizers.

Complexes of the rare earths are also used in the prior art for the marking or identification of biomolecules, such as proteins and nucleic acids. Once again, the sometimes low stability and poor solubility of the complexes is a disadvantage. Moreover, the luminescence signals obtained after excitation are often only weak and therefore are sometimes difficult to detect.

Furthermore, in the area of marking of biological systems, for example cellular systems, such as bacteria, viruses or phage, introducing the marking substance into the biological system itself or achieving uptake of the marking or luminescent dye by the biological system is often problematic, so that also against this background, optimal marking is not always possible in the prior art. In particular, the marking systems known from the prior art are not always biocompatible. Thus, for example so-called quantum dots often have (cyto)toxic properties.

Especially with luminescent or fluorescent dyes of the prior art, there are often nonspecific interactions between dye molecules on the one hand and the system to be labeled on the other hand, which can falsify the result. Moreover, often there is only slight separation or differentiation between excitation and the maximum emission—generally also called the Stokes shift, which makes differentiation and/or evaluation of the fluorescence signal more difficult.

In the prior art, one approach for better differentiation between maximum excitation and maximum emission is to use so-called tandem dyes, which are constructs with two fluorescent dyes, which lead, as a result of fluorescence-resonance energy transfer from donor to acceptor, to a broadening of the Stokes shift. Often the biocompatibility of said dyes is nonoptimal, and the production of these dyes is comparatively expensive and laborious, which in particular also militates against large-scale industrial application of these dyes for the marking of objects.

US 2008/0149895 A1 relates to a marking substance for marking objects or for their authentication. The marking substance is based on a silicon dioxide support, which is impregnated with a dye containing a rare-earth element and ligands, wherein the dye is to be integrated into the network structure. The marking system described in this document, which is made using alkoxysilanes as starting substance, comprises irregular bodies, in particular without long-range order, or irregular agglomerates, into which diffuse incorporation of the dye is said to take place. The overall production process is laborious, as the complete network structure must be produced on the basis of structural units. The system described there sometimes has poor dispersibility and is basically water-insoluble, which makes it more difficult to use for the labeling of biological systems. Owing to the diffuse distribution of the dye in the network structure, the marking system according to this document also does not always have optimal optical properties, along with nonoptimal emission characteristics. The problem to be solved by the present invention is to provide a method of providing marking substances, based on luminescent dyes, wherein the disadvantages of the prior art as outlined above are at least partially avoided or should at least be attenuated.

### BRIEF SUMMARY OF THE INVENTION

In particular, the problem to be solved by the present invention is to provide a method that is efficient and can be carried out as easily as possible, for the production of marking systems based on luminescent dyes, wherein the resultant marking systems should offer high performance, in particular with regard to use thereof in the area of the marking of objects, such as plastics, metals, fibers, textiles and/or paper, or of substrates containing biopolymers or consisting of biopolymers, and in the area of bioanalytics, in particular with respect to the labeling or identification of biological systems, such as cellular systems and biomolecules.

In particular, a problem to be solved by the present invention is to provide a luminescent dye suitable for purposes of marking, which along with good emission properties, has optimized application properties with respect to the marking of objects or with respect to the labeling and/or identification of biological systems, in particular with respect to emission properties, solubility properties, chemical stability and biocompatibility.

Therefore, according to a first aspect, the present invention relates to a method for producing a luminescent layered silicate composite, which is suitable in particular for the marking of objects or for the labeling and/or identification of biological systems, as claimed in original claim. 1; further advantageous embodiments of the method according to the invention are covered by the relevant original dependent claim.

The present invention further relates to a luminescent layered silicate composite as claimed in original claim 50.

The present invention further relates to a luminescent layered silicate composite as such as claimed in original claim 51; further advantageous embodiments are covered by the relevant original, dependent claim.

The present invention also relates—according to yet another object of the present invention—to a solution or dispersion as claimed in original claim 53, which contains at least one luminescent layered silicate composite according to the invention.

Moreover, the present invention relates—according to another aspect of the present invention—to the use as claimed in original claim 54 of at least one luminescent layered silicate composite according to the invention for labeling or identifying a target structure, in particular a target molecule; further advantageous embodiments of this aspect of the invention are covered, by the relevant original dependent claim.

The present invention further relates—according to yet another further aspect of the present invention—to the use of the luminescent layered silicate composite according to the invention for the luminescent labeling or identification of a target structure or target molecule as claimed in original claim 55; further advantageous embodiments are covered by the relevant original dependent claim.

The present invention also relates to a method for labeling or identifying at least one target structure, in particular a target molecule, as claimed in original claim 56; further advantageous embodiments are covered by the relevant original dependent claim.

The present invention further relates—according to another aspect of the present invention—to a layered silicate composite/target structure conjugate or layered silicate composite/target molecule conjugate as claimed in original claim 58; further advantageous embodiments of this aspect of the present invention are covered by the relevant original, dependent claim.

Finally the present invention relates—according to yet another further aspect of the present invention—to a layered silicate composite/target structure mixture or a layered silicate composite/target molecule mixture as claimed in original claim 59; further advantageous embodiments of this aspect of the present invention are covered by the relevant original dependent claim.

Of course, the special embodiments and implementations presented below, which are only described in connection with one aspect of the invention, also apply correspondingly to the other aspects of the invention, without this having to be mentioned expressly.

Furthermore, regarding all relative values or percentages stated below, a person skilled in the art can deviate from the ranges of values given below depending on the application or the individual case, while remaining within the scope of the present invention.

The invention is described below in detail and in particular with regard to special embodiments, wherein reference will also be made to the figures listed below, which further illustrate the present invention purely as examples, but without limiting the invention thereto.

### BRIEF DESCRIPTION OF THE DRAWINGS

FIG. 1 provides a schematic representation layered silicate used in the context of the present invention.

FIG. 2 illustrates the dependence of the surface of a layered silicate usable according to the invention in relation to the pH of the medium or solvent in which the layered silicate is located.

FIG. 3 illustrates in general, the behavior of a dispersion or solution of layered silicates in relation to the concentration of layered silicate in the dispersion or solution and in relation to the concentration of foreign ions or protons in the solution or dispersion.

FIG. 4. provides a schematic representation of a luminescent layered silicate composite produced by the method according to the invention, which comprises two layered silicates or two layered silicate sheets, between which the rare-earth complex is introduced or incorporated or added.

FIG. 5A provides a schematic representation of a luminescent layered silicate composite according to the invention, which for example is obtainable by the method according to the invention, and which has two layered silicates or two layered silicate sheets with in each case negative surface charge and with cations added thereto or arranged thereon.

FIG. 5B provides a schematic representation of a luminescent layered silicate composite according to the invention, which for example is obtainable by the method according to the invention, and which has two layered silicates or two layered silicate sheets with in each case negative surface charge and with cations added thereto or arranged thereon.

FIG. 6 illustrates the excitation and luminescence or emission spectrum of rare-earth complexes per se [(a) and (c)], namely Eu(ttfa₃).Phen (a), and Fu(ttfa)₃.(H₂O)₂, and of a luminescent layered silicate composite according to the invention (h), namely Eu(ttfa₃).Phen-LapRD, wherein LapRD refers to the layered silicate Laponite or Laponite® RD used according to the invention.

FIG. 7 provides emission spectra of luminescent layered silicate composites according to the invention [(b) with Eu(ttfa)₃.Phen-Lap (with Lap=Laponite®) and prelamination with a cation exchange of 10% with Mg²⁺ and loading of the layered silicate composite with volatile complexes of rare earths via the gas phase; and (d) with Eu(ttfa) Lap and prelamination with a cation exchange of 20% by Eu³⁺, and subsequent loading with the ligands Httfa via the gas phase] compared with rare-earth complexes per se [(a) Eu(ttfa)₃.Phen and (c) Eu(ttfa)₃.(H₂O)₂].

FIG. 8A illustrates a rare-earth complex or lanthanide complex usable within the scope of the present invention, wherein it is En(ttfa)₃(H₂O)₂ or [Tris(1-(2-Thenyl)-4,4,4-trifluorobutane-1,3-dionato)(diaquo)]-Ln, wherein. En is formed by a lanthanide, in particular by europium, preferably Eu (III) and “ttfa” denotes the aforementioned 1-(2-Thenyl)-4,4,4-trifluorobutane-1,3-dionato ligand.

FIG. 8B illustrates a lanthanide-based complex usable according to the invention, wherein it is Ln(ttfa)₃(Epoxyphen) or [(5,6-epoxy-1,10-phenanthrolino)-Tris(1-(2-Thenyl)-4,4,4-trifluorobutane-1,3-dionato)]-1,n, wherein En is formed by a lanthanide, preferably by europium, in particular Eu(III), the ligand “ttfa” has the meaning given above and the ligand “Epoxyphen” denotes the 5,6-epoxy-1,10-phenanthrolino ligand shown in FIG. 8B.

FIG. 9 illustrates a dye complex, such as can be used within the scope of the method according no the invention according to one embodiment for the production of the luminescent layered silicate composite according to the invention, wherein in this connection it is a FRET complex or a FRET system, which has a terbium complex (Tb) as donor fluorophor and a europium complex (Eu) as acceptor fluorophor.

FIG. 10 illustrates a schematic representation, according to which, within the scope of the method according to the invention, according to a special embodiment two layered silicates are, prior to introduction or addition of the rare-earth complex, coupled or joined together with an organic residue, in particular in the form of a spacer, so that in this way the subsequent introduction or incorporation or addition of the rare-earth complex is further improved.

### DETAILED DESCRIPTION OF THE INVENTION

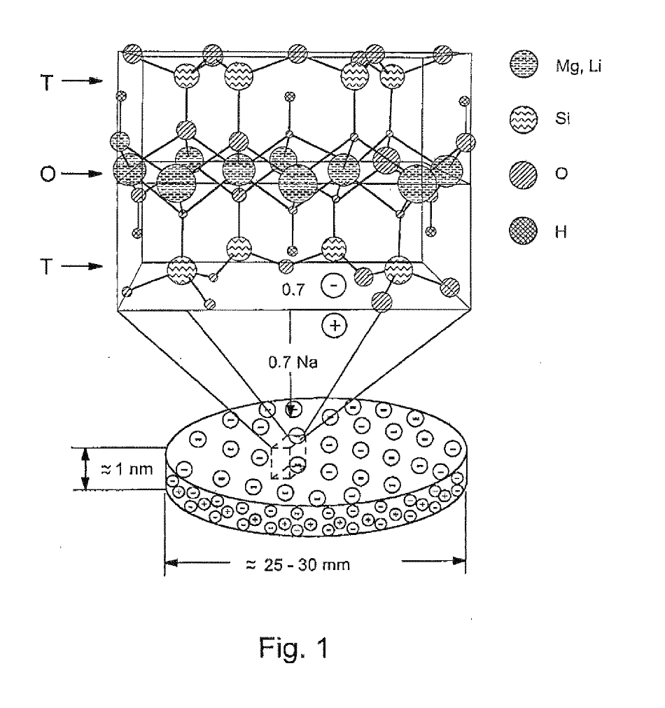

FIG. 1 provides a schematic representation of a layered silicate used in the context of the present invention for forming the layered silicate composite (bottom part of the figure) with a corresponding enlarged detail (top part of the figure), which illustrates the sheet-like structure within the layered silicate.

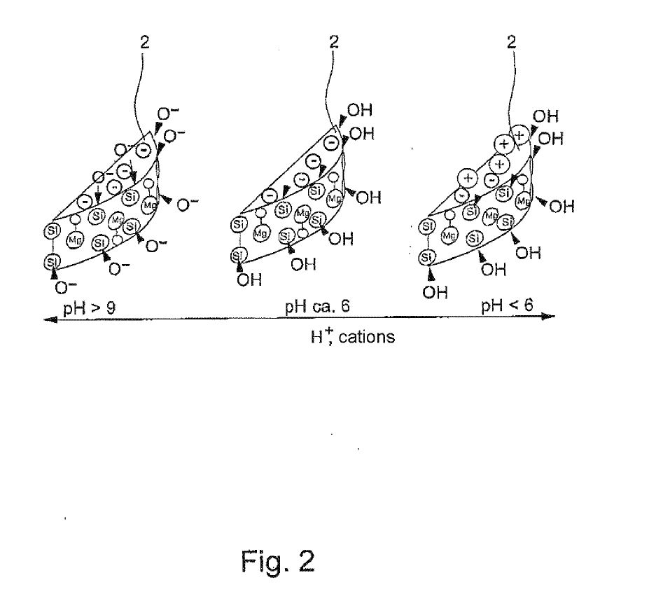

FIG. 2 illustrates the dependence of the surface of a layered silicate usable according to the invention in relation to the pH of the medium or solvent in which the layered silicate is located. At high pH there is extensive deprotonation of the surface of the layered silicate, which leads to a corresponding negative surface charge of the layered silicate. With decreasing pH, there is increasing protonation, first of the edges of the layered silicate, accompanied by decreasing negative edge charge and increasing protonation of the surface of the layered silicate accompanied by decreasing negative surface charge, wherein for low pH values with correspondingly high hydrogen ion concentration, there is corresponding protonation of the surface. An analogous effect can be achieved by adding cations.

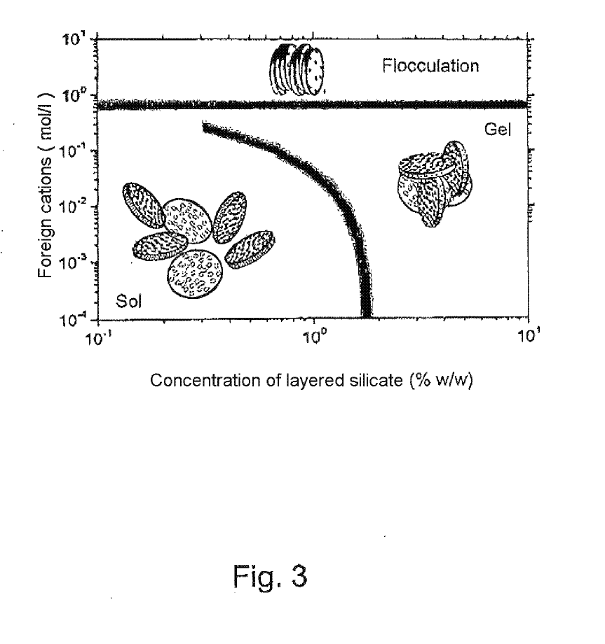

FIG. 3 illustrates, in general, the behavior of a dispersion or solution of layered silicates in relation to the concentration of layered silicate in the dispersion or solution and in relation to the concentration of foreign ions or protons in the solution or dispersion. At low concentration of layered silicates and low concentration of foreign cations, there may be a sol-like arrangement of the layered silicates in the solution or dispersion, wherein a gel-like state can be attained with increasing concentration of layered silicates. FIG. 3 shows, in addition, that for high concentrations of foreign cations there may be flocculation of the layered silicates.

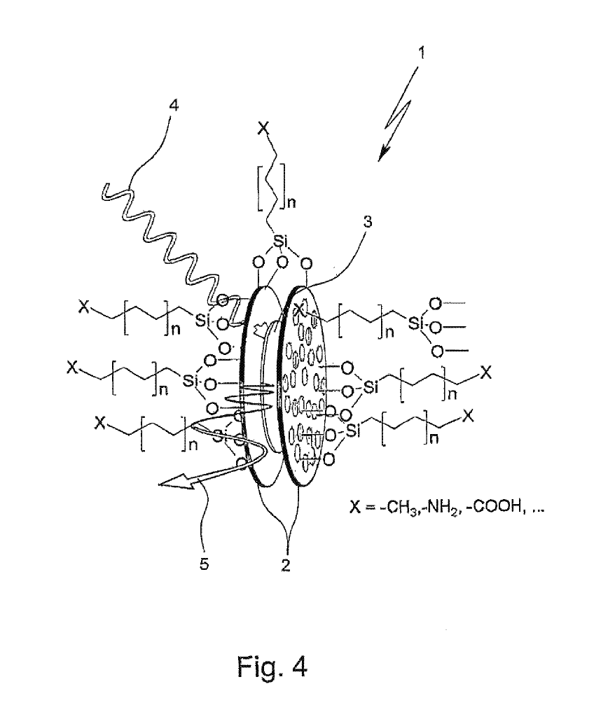

FIG. 4 provides a schematic representation of a luminescent layered silicate composite 1 produced by the method according to the invention, which comprises two layered silicates or two layered silicate sheets 2, between which the rare-earth complex 3 is introduced or incorporated or added. Under the action of excitation energy or absorption of excitation energy 4, there is development of luminescence 5, in particular fluorescence, of the luminescent layered silicate composite 1 according to the invention. In addition, FIG. 4 shows an embodiment of the invention, according to which the luminescent layered silicate composite according to the invention can be surface-modified with substituents or functional groups.

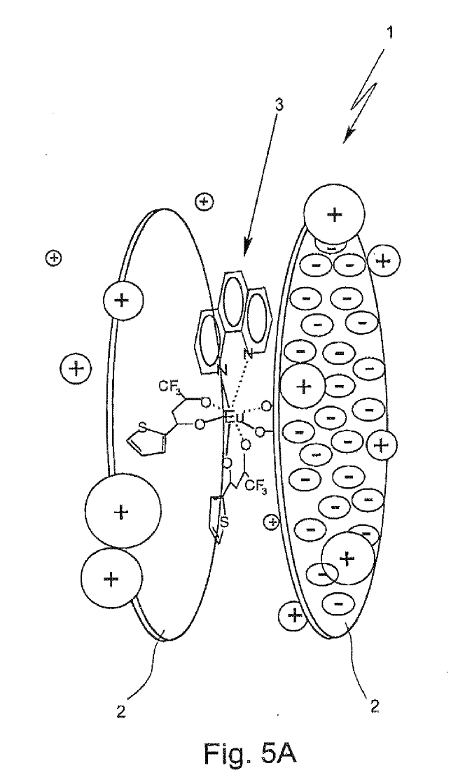

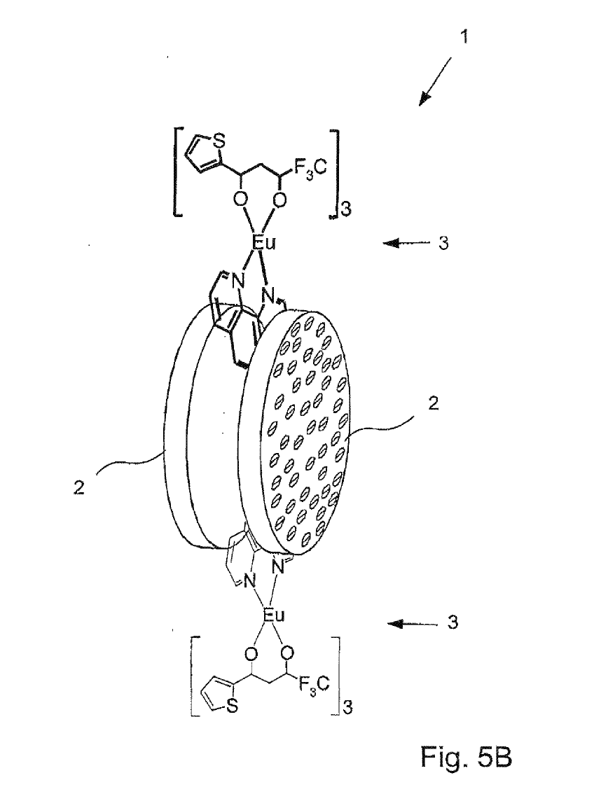

FIGS. 5A and 5B provide, in each case, a schematic representation of a luminescent layered silicate composite according to the invention, which example is obtainable by the method according to the invention, and which has two layered silicates or two layered silicate sheets 2 with in each case negative surface charge and with cations added thereto or arranged thereon in addition, FIG. 5A shows a rare-earth complex 3 based on a central atom or ion of a rare-earth element and ligands associated therewith or bound thereto, arranged between the layered silicate sheets 2 and therefore, as it were, in the region of the internal surfaces of the layered silicate sheets 2, whereas the rare-earth complex. 3 according to the schematic representation in FIG. 5B can also be arranged in the region of the edges or in the edge layer of the layered silicate sheets 2. For further details on the positioning or arrangement of the rare-earth complex 3, reference may be made to the explanations for FIG. 4.

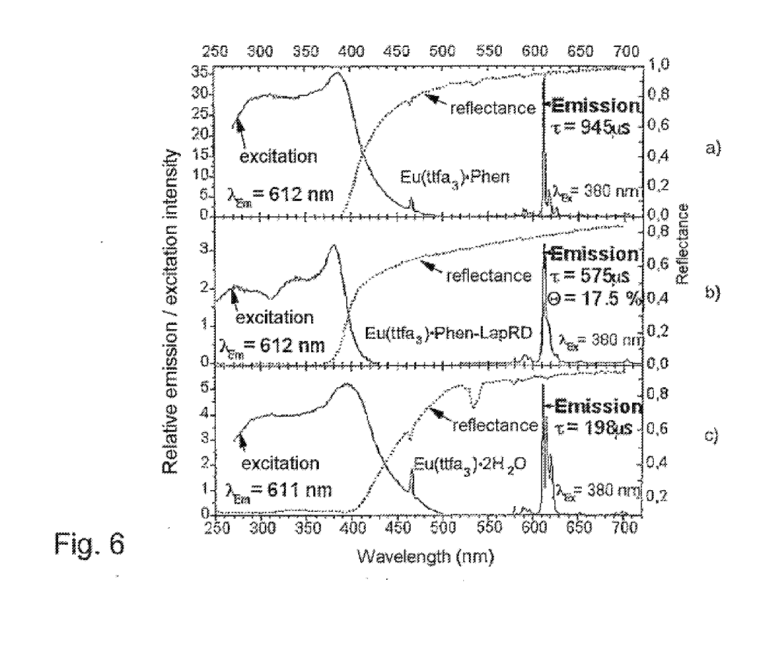

FIG. 6 provides the excitation and luminescence or emission spectrum of rare-earth complexes per se (FIGS. 6 a and c)), namely Eu(ttfa₃)₃.Phen (FIG. 6a), and Eu(ttfa)₃.(H₂O)₂, and of a luminescent layered silicate composite according to the invention (FIG. 6b), namely Eu(ttfa₃).Phen-LapRD, wherein LapRD refers to the layered silicate Laponite or Laponite® RD used according to the invention. In each case this results in a sharp or narrow-band emission spectrum with a maximum at 611 nm or 612 nm. The time constants of the emission of the complexes used are 198 μs (Eu(ttfa)₃.(H₂O)₂ according to FIG. 6c) up to 945 μs (Eu(ttfa)₃.Phen according to FIG. 6a)). “Phen” denotes 1,10-phenanthroline. “ttfa” designates a 1-(2-Thenyl)-4,4,4-trifluorobutane-1,3-dionato ligand. Therefore, compared with the rare-earth complexes as such, the layered silicate composite according to the invention does not have emission properties that are in any way impaired. Laponite is a registered U.S. trademark owned by Rockwood Additives, Limited Corporation United Kingdom, PO Box 2, Moorefield Road. Widnes, Cheshire WAB OJU England.

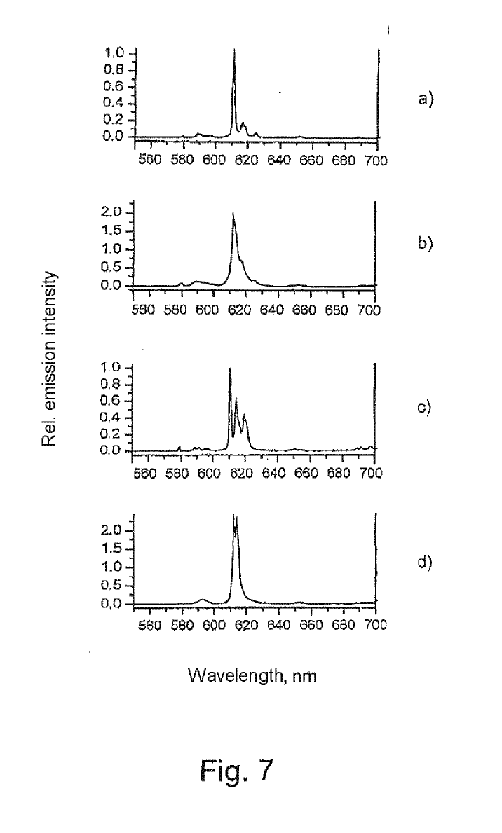

FIG. 7 is based on FIG. 7(b) and FIG. 7(d) emission spectra of luminescent layered silicate composites according to the invention [FIG. 7b) with Eu(ttfa)₃.Phen-Lap (with Lap=Laponite®) and prelamination with a cation exchange of 10% with Mg²⁺ and loading of the layered silicate composite with volatile complexes of rare earths via the gas phase; and FIG. 7d) with Eu(ttfa)₃-Lap and prelamination with a cation exchange of 20% by Eu³⁺, and subsequent loading with the ligands Httfa via the gas phase] compared with rare-earth complexes per se [FIG. 7a) Eu(ttfa)₃.Phen and FIG. 7c) Eu(ttfa)₃.(H₂O)₂]. The layered silicate composites according to the invention have, compared with the rare-earth complexes per se, equally excellent luminescence or emission properties, i.e. the layered silicate sheets do not have an adverse influence on the emission behavior.

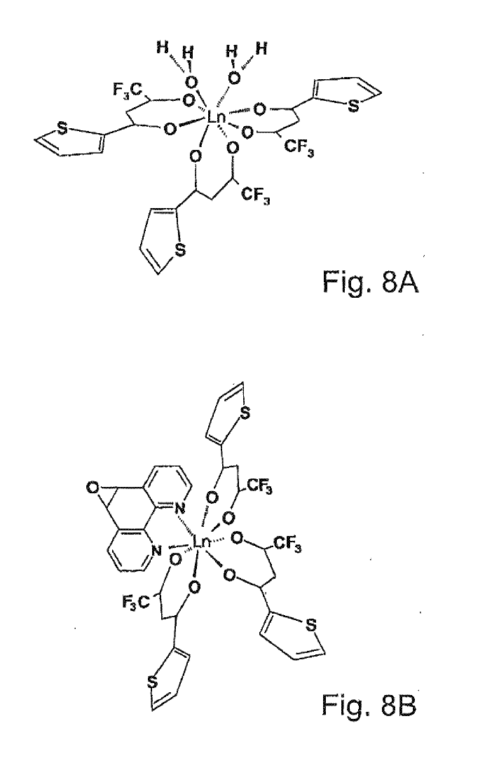

FIG. 8A illustrates a rare-earth complex or lanthanide complex usable within the scope of the present invention, wherein it is Ln(ttfa)₃(H₂O)₂ or [Tris (1-(2-Thenyl)-4,4,4-trifluorobutane-1,3-dionato)(diaquo)]-Ln, wherein to is formed by a lanthanide, in particular by europium, preferably Eu(III), and “ttfa” denotes the aforementioned 1-(2-Thenyl)-4,4,4-trifluorobutane-1,3-dionato ligand. The lanthanide complex according no FIG. 8A is suitable for introduction or incorporation or addition in the luminescent layered silicate composite according no the invention, for example by interaction or formation of coordinate bonds, wherein within the scope of the underlying reactions for example hydrogen or protons or water molecules can be split-off from the lanthanide complex.

FIG. 8B illustrates a lanthanide-based complex usable according to the invention, wherein it is Ln(ttfa)₃(Epoxyphen) or [(5,6-epoxy-1,10-phenanthrolino)-Tris(1-(2-Thenyl)-4,4,4-trifluorobutane-1,3-dionato)]-Ln, wherein to is formed by a lanthanide, preferably by europium, in particular Eu(III), the ligand “ttfa” has the meaning given above and the ligand “Epoxyphen” denotes the 5,6-epoxy-1,10-phenanthrolino ligand shown in FIG. 85. The lanthanide complex according to FIG. 85 is similarly suitable in particular for introduction or incorporation or addition between the layered silicate sheets for forming the luminescent layered silicate composite according to the invention.

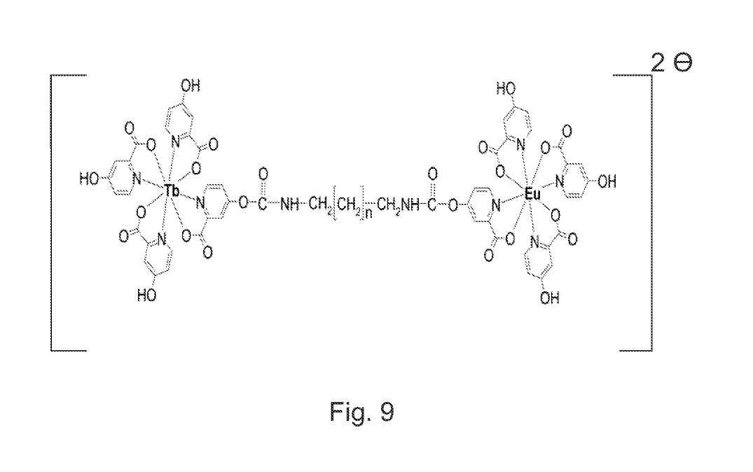

FIG. 9 illustrates a dye complex, such as can be used within the scope of the method according to the invention according one embodiment for the production of the luminescent layered silicate composite according to the invention, wherein in this connection it is a FRET complex or a FRET system, which has a terbium complex (Tb) as donor fluorophor and a europium complex (Eu) as acceptor fluorophor. The two fluorophors are joined together via an organic residue (“linker”). In the present case, under the action of or when irradiated with excitation energy, an in particular radiation-free energy transfer of the terbium complex to the europium complex can occur, accompanied by specific emission by the europium complex.

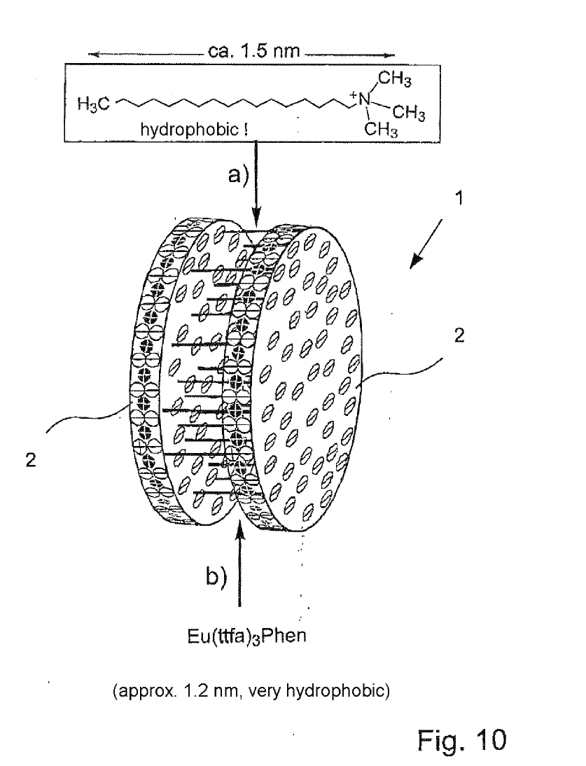

FIG. 10 illustrates a schematic representation, according to which, within the scope of the method according to the invention, according to a special embodiment, two layered silicates are, prior to introduction or addition of the rare-earth complex, coupled or joined together with an organic residue, in particular in the form of a spacer, so that in this way the subsequent introduction or incorporation or addition of the rare-earth complex is further improved.

According to a first aspect of the invention, the present invention therefore relates to a method for producing a luminescent layered silicate composite. The method according to the invention is characterized in that at least one luminescent dye, in particular fluorescent dye, based on at least one complex, in particular chelate complex, at least one rare-earth element (“rare-earth complex”) is introduced, and/or incorporated between at least two layers in each case of at least one layered silicate (“layered silicate sheets”) or in that at least one luminescent dye, in particular fluorescent dye, based on at least one complex, in particular chelate complex, of at least one rare-earth element (“rare-earth complex”) is made into a composite with a layered silicate, in particular wherein the luminescent dye is introduced and/or incorporated in and/or between at least two layers in each case of at least one layered silicate (“layered silicate sheets”) and/or is added to at least two layers in each case of at least one layered silicate (“layered silicate sheets”).

In other words, within the scope of the method according to the invention, two layers of layered silicates are arranged, by the introduction or incorporation or addition of at least one luminescent dye, into a stack-like or sandwich-like layered silicate composite, wherein the at least one luminescent dye is introduced or incorporated or added between the layers of layered silicates and is as it were flanked by this or as it were joins these. Thus, in the context of the present invention, a method is proposed in which at least two layers of a layered silicate can be said to be laminated by means of a dye complex in the manner of a “sandwich” or a “hamburger”, so that the dye complex or the luminescent dye functions as it were as connecting unit or bridge between two layered silicate sheets.

With regard to the layered silicate used within the scope of the method according to the invention, it is generally—as described in detail below—a layer-like structure, which is capable of interaction with the luminescent dye or of delamination for the purpose of subsequent interaction with the dye. Basically, the layered silicates or layered silicate sheets used are dispersible or water-soluble structures.

Within the scope of the method according to the invention, preferably exactly two layered silicates or layered silicate sheets are arranged, by introduction or incorporation or addition of at least one luminescent dye, preferably a large number of luminescent dye molecules, between two layers of the layered silicate to form the layered silicate composite according to the invention.

The applicant, found, quite surprisingly, that the disadvantages of the prior art described above can be overcome by providing the method according to the invention for producing a luminescent layered silicate composite or by providing the luminescent layered silicate composite according to the invention per se. The present invention is characterized by the provision of an efficient and cost-effective method, within the scope of which for example ordinary, commercially available layered silicates can be specified, using few process steps with the incorporation or introduction or addition of the luminescent dye, to luminescent layered silicate composites, which meet the high requirements relating no the marking of biological systems or of objects, such as plastics.

The present invention has the decisive advantage that, based on the method according to the invention, luminescent dyes are provided in the form of luminescent layered silicate composites, which on the one hand have the excellent properties of dye complexes based on a rare-earth element and on the other hand avoid the disadvantages that usually accompany the use of these complexes in the prior art.

Thus, in the context of the present invention, it has been possible, for the first time, to provide luminescent dyes using a rare-earth complex in the form of luminescent layered silicate composites, in which the actual dye complex is as it were flanked on both sides by layered silicate sheets, which quite surprisingly leads to avoidance of the disadvantages associated with the use of rare-earth complexes. Thus, within the scope of the present invention, without wishing to be bound to this theory, as it were based on the encapsulation of the rare-earth complex, the luminescent layered silicate composites obtainable by the method according to the invention have a high chemical or photochemical stability. Moreover, the layered silicate composites according to the invention have excellent dispersibility in solvents or even solubility in water, which makes them far easier to use, in particular for labeling biological, systems for example.

Another decisive advantage of the present invention is moreover the fact that the luminescent layered silicate composites according to the invention are optimized with respect to size or dimensions, so that an effective uptake or incorporation in biological systems, for example in the form of cellular systems (such as bacteria or the like), can take place for example by biological processes, such as endocytosis. In this connection, particularly good uptake or incorporation can take place if the luminescent layered silicate composite according to the invention has a size, in particular a diameter and/or a height, independently of one another, from about 5 to 150 nm, in particular 10 to 100 nm, preferably 15 to 50 nm, especially preferably about 30 nm.

Moreover, the luminescent layered silicate composites according to the invention on the whole have very good biocompatibility. In this connection it is also decisive that the present luminescent layered silicate composites according to the invention do not display cytotoxicity.

Moreover, the luminescent layered silicate composites according to the invention, provided on the basis of the method according to the invention, have, with respect to their luminescence properties, in particular fluorescence properties, the advantages that are in particular associated with the use of rare-earth complexes, in particular with respect to very narrow line emissions, a large Stokes shift and extremely long emission lifetimes. This leads to precise time-specific and wavelength-specific detection. Owing to the very narrow emission bands and the long fluorescence lifetimes of the dye signals, the luminescent layered silicate composites according to the invention differ decisively from the systems of the prior art. Thus, the fluorescence lifetime of the luminescent layered silicate composites provided according to the invention is significantly longer than the background fluorescence of organic compounds. Based on the long fluorescence lifetimes, a temporal discrimination of the signals of the layered silicate composite according to the invention with the rare-earth complex, in possible, for example by time-resolved fluorescence measurement.

Overall, therefore, within the scope of the method according to the invention, a high-performance luminescent layered silicate composite is provided according to the invention, which is eminently suitable for example for the marking of objects, such as plastics. In particular, based on the high chemical stability, dispersion in polymer systems is possible, wherein the layered silicate composites according to the invention, because of the surface modifiability, can as it were be tailor-made.

Thus, based on the special use of layered silicate sheets or layered silicates with, defined chemical (surface) properties, the luminescent layered silicate composites according to the invention can moreover for example be surface-modified specifically, for example for adjustment to the polarity of solvents that can be used or to matrixes, into which the luminescent layered silicate composite according to the invention is to be incorporated.

Another advantage of the present invention is that the luminescent layered silicate composites according to the invention are for example available in the form of transparent dispersions, so that basically they are not (light-)scattering.

In the context of the present invention it has on the whole been possible, in particular based on the use of layered silicates, to avoid the possibly disadvantageous dissolution properties or interactions of the rare-earth complexes with their chemical environment, in particular by embedding the rare-earth complexes in layered silicates. Based on the surface modifiability, moreover yet another improvement, of biocompatibility is possible, wherein the luminescent layered silicates according to the invention can as it were be adjusted to the biochemistry of the cell. Moreover, it is possible, in the context of the present invention—as described below—to achieve specificity with respect to the target molecules or the like that are to be labeled, by means of special attachment of functional groups.

The layered silicates used according to the invention, which generally are also referred to by the synonyms phyllosilicates or sheet silicates, are generally silicate structures with two-dimensionally—speaking figuratively—infinite layers of [SiO₄] tetrahedra, wherein each [SiO₄] tetrahedron can be joined by three bridging oxygens to adjacent tetrahedra; the [SiO₄] ratio is therefore 2:5 or [Si₂O₅]²⁻. As described in more detail below, in the context of the present invention, so-called two-layer lattices or two-layer phyllosilicates and especially preferably three-layer lattices or three-layer silicates can be used for forming the layered silicate structure according to the invention in the two-layer lattices, generally an Mg(OH)₂ and/or an Al(OH)₃ layer of octahedra is linked to an Si₂O₅ layer, The three-layer lattices consist of alternating tetrahedral layer/octahedral layer/tetrahedral layer. For further details about this, reference may be made for example to Römpp Chemlelexikon, Vol. 4, 10th edition, Georg-Thieme-Verlag, Stuttgart/New York, 1998, pages 3328/3329, headword: “Phyllosilicate”, and to the references given there, the respective contents of which are included herein by reference.

Moreover, for further information or explanations regarding layered silicates or phyllosilicates reference may be made to the definition according to Jasmond K. and Lagaly C, “Tonmineraie und Tone” [Clay minerals and clays], Steinkopffverlag, Darmstadt, 1993, pages 3 ff., the total disclosure contents of this literature being included by reference.

Within the scope of the method according to the invention, it is advantageous if the layered silicate forming the layers of the layered silicate or the layered silicate sheets is used in the form of discrete bodies with defined dimensions.

In this connection, it has proved especially advantageous if the layers of the layered silicate or the layered silicate sheets, independently of one another, have in all dimensional directions, in particular in two dimensional directions, a size of at most 100 nm, in particular at most 50 nm, preferably at most 25 nm.

Moreover, the layers of the layered silicate or the layered silicate sheets, independently of one another, should be formed at least essentially flat, in particular plate-shaped or slice-shaped and/or cylindrical, as shown for example in FIG. 1. In other words the individual layers of the layered silicate should be formed at least essentially “disk-shaped”, i.e. in particular should be in the form of a cylinder with at least essentially plane and/or circular bases.

Furthermore, within the scope of the method according to the invention, especially good results are obtained when the layers of the layered silicate or the layered silicate sheets, independently of one another, have a diameter of at most 100 nm, in particular at most 75 nm, preferably at most 50 nm, preferably at most 25 nm. Moreover, the layers of the layered silicate or the layered silicate sheets should have, independently of one another, a diameter in the range from 1 to 100 nm, in particular 5 to 75 nm, preferably 10 to 50 nm, preferably 15 to 25 nm.

Also regarding the layers of the layered silicate or the layered silicate sheets, these should have, independently of one another, a thickness of at most 10 nm, in particular at most 5 nm, preferably at most 2 nm, preferably at most 1.5 nm. In this connection, the layers of the layered silicate or the layered silicate sheets should have, independently of one another, a thickness in the range from 0.1 to 10 nm, in particular 0.2 to 5 nm, preferably 0.5 to 2 nm, preferably 0.7 to 1.5 nm. The term “thickness” of the layered silicate sheet, as understood within the scope of the present invention, relates in particular to the height of the layered silicate sheet, preferably formed in the shape of a cylinder.

The shape or spatial structure of the layered silicate sheets used according to the invention, as described above, is particularly advantageous, because on the one hand this provides good dispersibility in a solvent, such as water, or even solubility in water, which also applies to the luminescent layered silicate composites per se, produced within the scope of the method according to the invention. The good dispersibility or water solubility is advantageous in particular with respect to the use of the luminescent layered silicate composite produced by the method according to the invention for the labeling or identification of biological systems, such as biological cells or biomolecules. Moreover, this can also provide optimal If incorporation in systems that are to be marked, such as plastics.

In this connection, the term “solubility”, as used within the scope of the present invention, means that at least a proportion of the layered silicates used within the scope of the method according to the invention and the resulting luminescent layered silicate composite per se is as it were present in singular-particulate form in a solvent. In this respect, solvent means, in the context of the present invention, in particular water, but consideration may also be given to other polar solvents or organic solvents, as solvent in particular for the luminescent layered silicate composites obtained by the method according to the invention.

Within the scope of the method according to the invention, for production of the layered silicate composite according to the invention, the layered silicate used for forming the layered silicate sheets should be a swellable and/or at least essentially completely delaminating layered silicate. This means in particular that, based on the action of a solvent, such as water, or through at least partial ion exchange between initially stacked layered silicate sheets, at least partial delamination of the layered silicate sheets can be effected, which leads to the solubility of the delaminated or separated layered silicate sheets described above.

The term “delamination” or “delaminating”, as understood within the context of the present invention, relates to a spatial separation of individual layered silicate sheets based on the incorporation in particular of water or based on an exchange of ions between adjacent layered silicate sheets, accompanied by separation of individual layers.

In the delaminated state, the cations arranged between the layers are preferably hydrated, i.e. addition of water occurs, which sometimes leads to complete delamination of the layers in aqueous solution or suspension. The separated layered silicate sheets are then optimally accessible for the introduction or incorporation or addition of the rare-earth complex.

According to the invention, especially preferably, already delaminated layered silicate sheets are used, which are for example commercially available, and will be discussed later.

Moreover, according to the invention, two-layer silicates or two-layer clay minerals and/or three-layer silicates or three-layer clay minerals, preferably three-layer clay minerals or silicates, should be used as the layered silicate forming the layers. The previously mentioned two-layer silicates are also called synonymously 1:1-layered silicates, and the previously described three-layer silicates are generally also known as 2:1-layered silicates.

In this connection it is preferable according to the invention to use tetrahedral and/or octahedral layers, preferably tetrahedral and octahedral layers, in particular layered silicate containing or consisting of tetrahedral and dioctahedral layers, as the layered silicate forming the layered silicate sheets. In that case the tetrahedral layer should contain SiO₄ units and the octahedral layer should contain Mg(OH)₂ or Al(OH)₃ units, preferably Mg(OH)₂ units.

As already mentioned, the SiO₄ units or the [Si₂O₅]²⁻ units represent as it were the basic units for the tetrahedral layer, whereas the Mg(OH)₂ or Al(OH)₃ units form the basic units for the octahedral layer, and we generally refer to a trioctahedral layer, if aluminum is present in the corresponding layer, and a dioctahedral layer if magnesium is present in the corresponding layer. The aforementioned basic units represent as it were the underlying constituents or structural units for forming the layered silicate lattice structure, wherein in the lattice itself, through the arrangement of the units and/or through the formation of chemical bonds, for example a proportion of the hydroxyl groups can be replaced with oxygen bound to silicon. The chemical processes underlying formation of the lattice are well known per se by a person skilled in the art.

Generally the tetrahedral layers have negative surface charges, which can for example be compensated in solution on the surface by appropriate cations.

Moreover, it is preferred, in the context of the present invention, if the layered silicate sheets are selected in such a way that at least one base, preferably both bases, of the respective layered silicate sheet has or have a tetrahedral layer.

Therefore in the context of the present invention it is especially advantageous if a layered silicate with two tetrahedral layers and one octahedral layer is used as the layered silicate forming the layered silicate sheets. In that case the tetrahedral layers should form the outer layers of the layered silicate or of the respective layered silicate sheet. Moreover, the layered silicate forming the layered silicate sheets should be a three-layer silicate, preferably a dioctahedral three-layer silicate or a trioctahedral three-layer silicate.

As already mentioned, a three-layer silicate used especially preferably within the scope of the method according to the invention is shown schematically in FIG. 1, which has a so-called “TOT structure”, i.e. two outer tetrahedral layers (“T”) and one inner octahedral layer (“O”).

However, the present invention is not limited to the use of the aforementioned two- or three-layer silicates. In this connection, within the scope of the method according to the invention it is also possible to use multilayer silicates etc. for the layered silicate sheets, generally with the proviso that at least one outer layer of the layered silicate sheet is a tetrahedral layer in the sense of the definition given above, in particular with a negative surface charge.

In this connection, the layered silicate forming the layered silicate sheets can be selected from the group comprising magnesium silicates, magnesium-lithium silicates, magnesium-aluminum silicates, aluminum silicates and iron-aluminum silicates, preferably magnesium silicates and magnesium-lithium silicates.

Furthermore, the layered silicate forming the layered silicate sheets should be selected from layered silicates with a layer charge in the range from 0 to 2, in particular 0.1 to 1.0, preferably 0.2 to 0.8, more preferably 0.25 to 0.6, and especially preferably 0.3 to 0.4. In this connection, the aforementioned layered silicates should be a three-layer silicate from the smectite group.

Within the scope of the present invention, the layered silicate forming the layered silicate sheets can in particular be a sellable layered silicate from the serpentine-kaolinite group. As already mentioned, in the context of the present invention, in particular a sellable layered silicate from the smectite group, and especially a dioctahedral smectite and/or a trioctahedral smectite, may also be considered for selection as the layered silicate forming the layered silicate sheets. The layered silicate forming the layered silicate sheets can also be in particular a swellable layered silicate from the vermiculite group, in particular a dioctahedral vermiculite and/or a trioctahedral vermiculite.

It is especially preferable to use a three-layer silicate from the group of smectites and vermiculites, in particular the smectites, as the layered silicate forming the layered silicate sheets.

Also with respect to the layered silicate, it should be a trioctahedral smectite, in particular hectorite, preferably a hectorite containing or consisting of one of the elements. Na, Li, Mg, Si and O (including OH).

In general, the layered silicate forming the layered silicate sheets can be selected from the group comprising beidellite, montmorillonite, nontronite, saponite and hectorite, preferably hectorite.

According to a particularly preferred embodiment, a hectorite based on commercially available Laponite or Laponite® can be used. This is an already delaminated layered silicate, which in the context of the present invention is especially advantageous, as the process step of delamination can be omitted. These layered silicates are commercially available and for example are marketed by the Rockwood Specialties Group, Inc., Princeton, N.J., USA. In this connection, for example the commercially available Laponites with the specification RD, XLG, D or DF, especially preferably Laponite or Laponite® RD, can be used. The aforementioned Laponites are special sodium/magnesium silicates.

According to the invention, use of Laponites with the specification RDS, XLS or DS may also be considered, which are special sodium/magnesium silicates or tetrasodium pyrophosphates. The Laponites are generally three-layer silicates with in each case an outer tetrahedral layer.

According to the invention, a layered silicate with the general formula

[(Met⁺)ₐ,(Met′²⁺)_{b},(Met″³⁺)_{c}]^{(a+2b+3c)+}[Si_{d}Oₑ(Me⁺)_{f}(Me′²⁺)_{g}(Me″³⁺)ₕ(OH)ᵢXⱼ]^{(a+2b+3c)-}

can be used as the layered silicate forming the layered silicate sheets,
wherein Met is selected from the group of alkali metals, in particular lithium, sodium, potassium, rubidium, preferably lithium, sodium and potassium, especially preferably sodium and potassium, quite especially preferably sodium,
wherein Met′ is selected from the group of alkaline-earth metals, in particular magnesium and calcium, preferably magnesium,
wherein Met″ is selected from the lanthanide group, in particular europium and/or terbium, preferably europium, iron and aluminum,
wherein Me is selected from the group of alkali metals, in particular lithium, sodium, potassium, rubidium, preferably lithium and sodium, preferably lithium,
wherein Me′ is selected from the group of alkaline-earth metals, in particular magnesium and calcium, preferably magnesium,
wherein Me″ is selected from the lanthanide group, in particular europium and/or terbium, preferably europium, iron, boron and aluminum,
wherein X is, selected from the halides, in particular fluorine, chlorine and/or bromine, preferably fluorine, and mixtures thereof,
wherein a, b and c, independently of one another, in each case represent a rational number from 0 to 3, but with the proviso that a, b and c may not all be 0 simultaneously, in particular wherein a+b+c≦3,
wherein d represents a rational number≧1, in particular a rational number from 4 to 20,
wherein e represents a rational number≧10, in particular a rational number from 10 to 50,
wherein f, g and h, independently of one another, each represent a rational number from 0 to 10, but with the proviso that f, g and h may not all be 0 simultaneously,
wherein i represents a rational number≧1, in particular a rational number from 1 to 10,
wherein j represents a rational number from 0 to 5 and
with the general proviso that |a+2b+3c|=|4d−2e+f+2g+3h−i|.

Within the scope of the method according so the invention, it is advantageous if a layered silicate with the general formula (M⁺)ₓ[(Si₈Me_{5.5}M′_{0.3})O₂₀(OH)₄]^{x-} is used as the layered silicate forming the layered silicate sheets,

wherein M is selected from the group of alkali metals, in particular lithium, sodium, potassium, rubidium, preferably lithium, sodium and potassium, especially preferably sodium and potassium, quite especially preferably sodium,
wherein M′ is selected from the group of alkali metals, in particular lithium, sodium, potassium, rubidium, preferably lithium and sodium, preferably lithium,
wherein Me is selected from the group of alkaline-earth metals and aluminum, preferably from the group of alkaline-earth metals, in particular magnesium and calcium, preferably magnesium, and
wherein x denotes the charge and is a rational number in the range 0.1 to 1, in particular 0.15 to 0.9, preferably 0.2 to 0.8, more preferably 0.5 to 0.8, and especially preferably 0.7.

Moreover, it is possible, within the scope of the present invention, for a layered silicate with the general formula (Na⁺)_{0.7}[(Si₈Mg_{5.5}Li_{0.3})O₂₀(OH)₄]^{0.7-} to be used as the layered silicate forming the layered silicate sheets.

Moreover, it is possible, within the scope of the present invention, for a layered silicate with the general formula (M⁺)_{x′}[(Si₈Me_{5.5}M′_{0.3})O₂₀(OH)_{2.5}F_{1.5}]^{x′-} to be used as the layered silicate forming the layered silicate sheets,

wherein M is selected from the group of alkali, metals, in particular lithium, sodium, potassium, rubidium, preferably lithium, sodium and potassium, especially preferably sodium and potassium, quite especially preferably sodium,
wherein M′ is selected from the group of alkali metals, in particular lithium, sodium, potassium, rubidium, preferably lithium and sodium, preferably lithium,
wherein Me is selected from the group of alkaline-earth metals and aluminum, preferably from the group of alkaline-earth metals, In particular magnesium and calcium, preferably magnesium, and
wherein x′ denotes the charge and is a rational number between 0.1 and 1, in particular 0.15 to 0.9, preferably 0.2 to 0.8, more preferably 0.5 to 0.8, and especially preferably 0.7.

Furthermore, it can be envisaged, within the scope of the present invention, that a layered silicate with the general formula (Na⁺)_{0.7}[(Si₈Mg_{5.5}Li_{0.3}) O₂₀(OH)_{2.5}F_{1.5}]^{0.7-} is used as the layered silicate forming the layers.

With regard to the two-layer and three-layer silicates or clay minerals that can be used according to the invention, generally the OH groups can be replaced completely or partially with other monovalent anions, Si with other tetravalent cations and Al with other trivalent cations. Moreover, basically, in the stoichiometries given above, replacements or substitutions or partial replacements or substitutions of silicon with pentavalent ions are also possible, wherein in this connection, in particular for reasons of charge compensation, for each silicon atom replaced, at the same time another cation should be replaced with a lower-valent cation. Thus, within the scope of the present invention it is also possible to use two- and three-layer silicates in which a partial or complete exchange, preferably partial exchange, of Si⁴⁺ for P⁵⁺, Mg²⁺ for Li⁺ and/or Al³⁺ for Mg²⁺ is possible. Exchange of Si⁴⁺ for Al³⁺ and vice versa is also possible. Further possible substitution schemes then also result, on the basis of the replacement according to two Si⁴⁺ for P⁵⁺, in a compensation according to Al³⁺ for Mg²⁺ and simultaneously, at least partial replacement of Mg²⁺ for Li⁺. A possible replacement of Al³⁺ with P⁵⁺ is also possible. Within the scope of the present invention, on the whole two- and three-layer silicates are preferred that comprise or consist of the elements Na, Li, Mg, Al, Si and O (including OH).

Within the scope of the present invention, the use of different layered silicates for the respective layered silicate sheets may of course also be considered.

Moreover, with regard to the method according to the invention for production of the luminescent layered silicate composite, is especially preferred if the at least two layered silicate sheets are arranged one above the other or are positioned one above the other and are linked or joined together. In this respect, the luminescent dye should be introduced or incorporated or added between these at least two layered silicate sheets, so that within the scope of the present invention, overall a luminescent layered silicate composite is obtained, which preferably has a layered silicate sheet/rare-earth complex/layered silicate sheet structure in the manner of a sandwich structure, as shown for example in FIG. 4 and FIG. 5A/E.

In this connection, the layered silicate sheets are for example arranged one above the other within the luminescent layered silicate composite according to the invention, in such a way that the tetrahedral layers of the respective layered silicate sheets are opposite one another, in particular wherein the luminescent dye is introduced or incorporated or added between these at least two layered silicate sheets.

The method according to the invention is further characterized in that according to a preferred embodiment, according to the invention the at least two layered silicate sheets are arranged one above the other in such a way that the respective bases of the in particular flat, preferably plate-shaped or slice-shaped and/or cylindrical layered silicate sheets are opposite one another. As already mentioned, the luminescent dye is introduced or incorporated or added between these at least two layered silicate sheets.

Within the scope of the method according to the invention, the at least two layered silicate sheets should be arranged at least essentially plane-parallel or sandwich-like one above the other. As already mentioned, the luminescent dye is introduced or incorporated or added between these at least two layered silicate sheets.

In other words, within the scope of the method according to the invention, the respective layered silicate sheets are as it were stacked flat on top of one another, with incorporation or introduction or addition of the rare-earth complex, thus resulting as it were in a “double decker” based on two layered silicate sheets with their respective bases arranged next to each other, with the rare-earth complex incorporated or introduced or added between them.

Within the scope of the method according to the invention, it can be envisaged that the luminescent dye is caused to interact with at least one of the at least two layered silicate sheets, preferably with the at least two layered silicate sheets. In this respect, in particular a physical and/or chemical bonding may be considered. Therefore it can be envisaged within the scope of the method according to the invention that the luminescent dye is bound physically and/or chemically to at least one, preferably to at least two layered silicate sheets.

Moreover, it can be envisaged within the scope of the method according to the invention that the luminescent dye is coupled and/or bound physically to at least one of the at least two layered silicate sheets, preferably with the at least two layered silicate sheets. In this respect, a large number of interactions or bonds may be considered, and we may mention, non-exhaustively, in particular the development of van der Waals interactions, electrostatic and/or Coulomb interactions and/or dipole/dipole interactions and/or dipole/ion interactions.

The luminescent dye or the rare-earth complex can also or alternatively be coupled or bound chemically with at least one of the at least two layered silicate sheets, preferably with the at least two layered silicate sheets, in particular with formation of ionic bonds and/or coordinate bonds and/or covalent bonds.

The aforementioned interactions between luminescent dye or rare-earth complex on the one hand and layered silicate on the other hand result as it were in the layered silicate sheets stacked on top of one another being joined together via the luminescent dye, so that overall a chemically stable structural unit is produced, which also has high photochemical stability. Furthermore, the hydrophobic rare-earth complex is as it were screened off by the hydrophilic sheets, leading to good solubility.

According to a particularly preferred embodiment of the invention, within the scope of the method according to the invention for production of the layered silicate composite, at least two layers of a three-layer silicate are bound or arranged together plane-parallel in the interlayer, in particular in the form of a Laponite with a luminescent dye or rare-earth complex.

However, the method according to the invention is not limited to the formation of a luminescent layered silicate composite based on a “double decker” with two layered silicate sheets:

Rather, it is also possible, within the scope of the present invention, that at least one further layered silicate sheet, identical or different, is arranged or applied on at least one of the at least two layered silicate sheets on their side opposite to the introduced and/or incorporated and/or added luminescent dye. In this respect, a possible procedure is for example that the luminescent dye is introduced or incorporated or added between the at least one further layered silicate sheet and the opposite layered silicate sheet (s), in particular as defined above.

Therefore, on the basis of the method according to the invention, luminescent, composite layered silicates can also be formed in the manner of a “triple decker”, “tetradecker”, etc., and then further layered silicate sheets with or without introduced or incorporated or added luminescent dye can be applied on one or both sides of the luminescent layered silicate composite based on two layered silicate sheets with luminescent dye introduced or incorporated or added therein.

Regarding the complex of the rare-earth element (“rare-earth complex”) used within the scope of the present invention, in this respect the rare-earth element should be selected from the group comprising scandium, yttrium, lanthanum, cerium, praseodymium, neodymium, promethium, samarium, europium, gadolinium, terbium, dysprosium, holmium, erbium, thulium, ytterbium and lutetium, preferably europium.

In particular, it can be envisaged according to the invention that the rare-earth element is selected from the lanthanides, in particular from the group comprising cerium, praseodymium, neodymium, promethium, samarium, europium, gadolinium, terbium, dysprosium, holmium, erbium, thulium, ytterbium and lutetium, preferably europium.

The lanthanides are relatively soft, reactive metals with a silvery shine, which oxidize rapidly in the air, becoming dull. They decompose more or less rapidly in water, with evolution of hydrogen gas. The lanthanides generally represent a total of fourteen elements of the sixth period of the periodic table, which can be regarded as a subsidiary group of the third subgroup. Owing to the similar structure of the valence shell, the lanthanides behave chemically like the elements of the third group of the periodic table, namely scandium and yttrium. With these, the lanthanides for the rare-earth group.

Especially good results with respect to the method according to the invention or the luminescent layered silicate composite according to the invention obtainable thereby are achieved when the rare-earth element is selected from europium and terbium, in particular in the form of europium(III) or terbium(III).

It is preferable to use europium as the rare-earth element, in particular in the form of europium(III).

Furthermore, it is advantageous if the luminescent dye, in particular the complex of the rare-earth element (“rare-earth complex”), is at least mononuclear, preferably is of mononuclear form and/or preferably has one rare-earth element.

Also with regard to the luminescent dye, in particular the complex of the rare-earth element (“rare-earth complex”), this should have at least one organic, in particular aromatic, preferably coordinate-bound ligand. Furthermore, the luminescent dye, in particular the complex of the rare-earth element, should have at least one organic, preferably coordinate-bound ligand based on β-diketone or based on β-diketonate, optionally together with at least one coligand based on bipyridines and/or phenanthrolines. It can also be possible, within the scope of the present invention, for the luminescent by in particular the complex of the rare-earth element, so have at least one ligand based on picolinic acid, picolinates and/or derivatives thereof, in particular substituted derivatives, preferably hydroxy derivatives, preferably hydroxypicolinic acid and/or hydroxypicolinate.

The ligands have in particular an important function as “antenna molecules” for absorbing excitation energy. Moreover, the Ii and can for example function as complexing agent or chelating agent with respect to the rare-earth element. In this connection, the rare-earth element can be bound ionically, coordinately and/or covalently, in particular covalently, to at least one ligand, in particular to several ligands, preferably to four ligands.

The ligands, in particular the complexing and/or chelating agents, can, independently of one another, be of multidentate, in particular bidentate form.

The organic, preferably coordinate-bound ligand based on β-diketone can be selected from the group comprising benzoyltrifluoroacetone, p-chlorobenzoyitrifluoroacetone, p-bromobenzoyltrifluoroacetone, phenylbenzovltriflubroacetone, l-naphthoyitrifluoroacetone, 2-naphthoyltrifluoroacetone, 2-phenanthroyltrifluoroacetone, 3-phenanthroylti-difluoroacetone, 9-anthroyltrifluoroacetone, cinnamoyitrifluoroacetone and 2-thenoyltrifluoroacetone.

For forming luminescent rare-earth complexes, in addition to the β-diketones described above, aromatic carboxylic acids and derivatives thereof, for example benzoic acid, pyridine carboxylic acid, bipyridine carboxylic acid or cinnamic acid, may also be considered as ligands.

Within the scope of the present invention, it is especially advantageous if the luminescent dye, in particular the complex of the rare-earth element, comprises or represents a fluorophor, in particular a dye constituent, preferably a luminescent and/or fluorescent dye constituent. This is achieved within the scope of the present invention in particular by specially matching the nucleus or central particle or atom based on the rare-earth element, on the one hand and the specific choice of ligand, so that within the scope of the present invention on the whole an extremely powerful, luminescent dye system is used for the luminescent layered silicate composites according to the invention.

According to one embodiment of the invention, the luminescent dye, in particular the complex of the rare-earth element, can correspond to the formula according to FIG. 8A, with “Ln” representing a rare-earth element, in particular as defined above, preferably europium, especially preferably in the form of europium(III).

According to another embodiment of the invention, the luminescent dye, in particular the complex of the rare-earth element, can correspond to the formula according to FIG. 5B, with “Ln” representing a rare-earth element, in particular as defined above, preferably europium, especially preferably in the form of europium(III).

For further relevant information on the specific complex of the rare-earth element, reference may be made to the descriptions for FIG. 8A and FIG. 8B.

According to another embodiment of the present invention, the luminescent dye, in particular the complex of the rare-earth element, can correspond to the formula according to general formula (I)

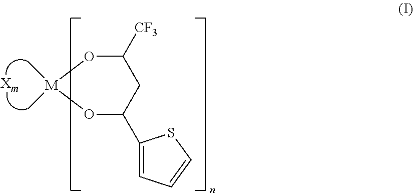

wherein:
“M” represents a rare-earth element, in particular as defined above, preferably europium, especially preferably in the form of europium(III),
“n” denotes an integer from 1 to 3, preferably 2 or 3,
“m” denotes an integer from 1 to 3, preferably 1, and
“X” represents a ligand of the following formula:

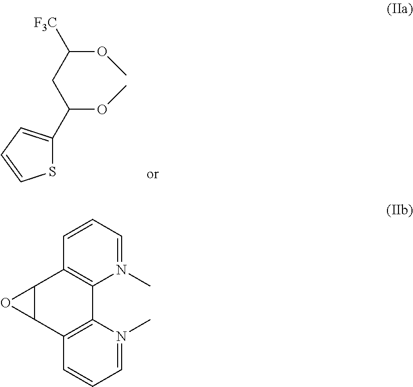

Regarding the previously mentioned formula (I) according to the invention it is advantageous to have n=2, if X represents a residue of formula (IIa), and/or to have n=3, if X represents a residue of formula (IIb), and/or for the complex of general formula (I) in addition preferably to have coordinate-bound water, preferably two water molecules per molecule of complex, especially if X represents a residue of formula (IIa).

For further information on the luminescent dyes usable within the scope of the present invention, in particular rare-earth complexes, reference may be made to German patent application DE 10 2008 048 605 and to DE 10 2006 033 871 and to German patent DE 102 59 677 B4, the complete contents of which are hereby included by reference in their entirety.

Within the scope of the present invention, the luminescent dye or the rare-earth complex can for example be selected from tetra (4-hydroxypyridine-2-carboxylato)europium(III), Tris(pyridine-2-carboxylato) (4-hydroxypyridine-2-carboxylato)europium(iii), bis(pyridine-2-carboxylato)-bis(4-hydroxypyridine-2-carboxylato)europium(III), (pyridine-2-carboxylato)-Tris(4-hydroxypyridine-2-carboxylato)europium(iii) and/or derivatives thereof. The luminescent dye or rare-earth complex can moreover be selected from tetra(4-hydroxypyridine-2-carboxylato)terbium(III), Tris-(pyridine-2-carboxylato)(4-hydroxypyridine-2-carboxylato)terbium(iii), bis(pyridine-2-carboxylato)-bis(4-hydroxypyridine-2-carboxylato)terbium(III), (pyridine-2-carboxylato)-Tris(4-hydroxypyridine-2-carboxylato)terbium(iii) and/or derivatives thereof.

The use of europium, in particular europium(III), is preferred according to the invention. The use of terbium(III) is, within the scope of the present invention, in particular possible when at least two different luminescent dyes are used in a layered silicate composite according to the invention, for example one dye based on a rare-earth complex with europium (III) and another luminescent dye based on a rare-earth complex with terbium(III).

Regarding the luminescent dye, in particular the rare-earth complex, a compound of general formula.

[Lnᵤ(Pic)_{y}(Pic-Y)_{z}]^{(4-3u)-}

may also be considered, wherein in the above formula
Ln is a rare-earth element, in particular as defined above, preferably europium, especially preferably in the form of europium(III), terbium(III),
Pic is picolinate,
Y is a functional group, in particular selected from the group comprising amino, carboxylate, isocyanate, thioisocyanate, epoxy, thiol and hydroxyl groups, preferably a hydroxyl group,
u is an integer from 1 to 4, in particular 1 or 2, preferably 1, and
y and z are in each case an integer from 0 to 4 with y+z−4.

Within the scope of the present invention, it is also possible for at least two mutually different rare-earth complexes, in particular as defined above, to be used as luminescent dye.

Thus, within the scope of the present invention it is possible for two mutually different rare-earth complexes, in particular as described above in each case, to be used as luminescent dye. In this connection, the first rare-earth complex can be selected in such a way that europium, preferably in the form of europium(III), is used as rare-earth element. The second rare-earth complex can be selected in such a way that terbium, in particular in the form of terbium(III), is used as rare-earth element.

In this regard, the rare-earth complexes can be formed as fluorescence resonance energy transfer pair (FRET pair). In this connection, the rare-earth complexes can be selected in such a way that the rare-earth complexes are capable of forming, together, a fluorescence resonance energy transfer (FRET).

Regarding the formation of the luminescent dye in the form of a FRET pair, in this respect the first rare-earth complex, which preferably comprises europium(III) as rare-earth element, can function as so-called acceptor fluorophor, whereas the second rare-earth complex, which preferably comprises terbium(III) as rare-earth element, functions as donor fluorophor in the sense of a fluorescence resonance energy transfer. In this connection it is possible according to the invention for the rare-earth complexes to be coupled or joined together via an in particular divalent organic residue, in particular a linker or a spacer. In this connection the organic residue should be selected in such a way that a fluorescence energy transfer can take place between the rare-earth complexes.

The term “fluorescence resonance energy transfer” and the associated physicochemical processes are well known per se by a person skilled in the art, and therefore do not require any further explanation. Through appropriate selection of the linker, FRET pairs or FRET probes defined according to the invention can be used, for which, by means of the defined spatial arrangement of the acceptor fluorophor to the donor fluorophor, an optimization or tailoring can be performed, so that with the fluorophors positioned close together, there can be optimal fluorescence energy transfer in the sense of maximum quenching of the donor signal, and with increasing distance apart, the result is a well-defined alteration of the emission spectrum with sharp bands and long emission times. In this way it is possible as it were to tailor the emission signal of the acceptor fluorophor.

The organic residue functioning as linker or spacer molecule can be coupled or bound to the respective substituent or to the respective functional group of the ligand, in particular complexing agent and/or chelating agent, in particular as defined above.

It can also be envisaged, within the scope of the present invention, that the luminescent dye, in particular the rare-earth complex, is an organometallic complex according to the formula in FIG. 9. For further relevant information, reference may be made to FIG. 9, described below. Regarding the formula in FIG. 9, n represents an integer, which defines the length of the organic residue (“linker”). By means of variable spacing of the fluorophors, it is possible to adjust or tailor the fluorescence resonance energy transfer (FRET) between these fluorophors.

According to this embodiment of the invention, therefore a FRET pair or a FRET probe is as it were introduced or incorporated or added between the layered silicate sheets.

The rare-earth complexes can on the whole be of a molecular, polymeric or nanoparticulate nature.

Regarding the layers in each case of at least one layered silicate (“layered silicate sheets”) used within the scope of the method according to the invention, it is especially preferred according to the invention if the layered silicate sheets are used in delaminated and/or delaminating form. This is to be regarded as a decisive simplification of the method according to the invention, namely in that a prior delamination step is omitted completely. As already mentioned, layered silicates of this kind are commercially available, for example the Laponites described above, which are delaminated layered silicates or layered silicate sheets. Therefore, according to this particularly preferred embodiment, the method according to the invention is based on layered silicates or layered silicate sheets that have already been delaminated, i.e. are used within the scope of the method according to the invention.

According to an alternative embodiment, however, it is also possible within the scope of the present invention to use nondelamlnated and accordingly laminated or not completely delaminated layered silicates. In such a case when laminated or not completely delaminated layered silicates are used, the method according to the invention can be preceded by a process step of delamination.

For delamination of the layered silicates or for obtaining delaminated layered silicate sheets, it is possible so use methods that are known per se by a person skilled in the art, which can in this respect, for example and non-exhaustively, be dialysis, ionic dehydration or the like. In this connection, or example hydration of the ions arranged between the nondelaminated or laminated silicate layers, such as sodium ions, can take place, so as to achieve spacing and as it were detachment of the layered silicate sheets from one another and accordingly delamination thereof. In addition, a demineralization or a treatment with an alkaline liquid phase, for example a solution based on NaOH, ammonia or the like, can be carried out, so that cations are detached from the interlayer bounded by two continuous layered silicate sheets. Electrostatic stabilization of the free SiO⁻ groups can then take place.

Within the scope of the method according to the invention, according to an especially preferred embodiment, it can moreover be envisaged that, with regard to the at least essentially delaminated layered silicate sheets, before the step of introducing or incorporating or adding the at least one rare-earth complex between at least two layered silicate sheets, an at least partial prelamination of the layered silicate sheets or of the layered silicates is carried out. By means of prelamination, delaminated layered silicates can deliberately be made to form two-layer or multilayer, preferably two-layer, sandwich-like layer structures based on the previously described “double decker”, “triple decker” etc., in which luminescent species or the at least one rare-earth complex can then be incorporated or introduced or added. As already mentioned, within the scope of the method according to the invention, preferably exactly two layered silicates are prelaminated for the purposes of subsequent incorporation of the rare-earth complex.

During the prelamination of the layered silicate sheets, in addition an at least partial ion exchange, in particular cation exchange, can be carried out on the surface of the layered silicate sheets in this connection, cations that are present on the surface of the delaminated layered silicate sheets, such as in particular monovalent sodium ions and/or potassium ions or the like, can generally be exchanged for preferably di- and/or trivalent cations, for electrostatic stabilization within the scope of formation of the layer structure and therefore for the deliberate formation of prelaminated two-layer or multilayer, preferably two-layer layered silicates.

In this respect, within the scope of prelamination, a possible procedure is to carry out ion exchange with cations from the group of alkali metals, alkaline-earth metals and/or ions from the rare-earth group, preferably with ions from the group of alkaline-earth metals, preferably magnesium, and/or the rare earths, preferably europium.

The cations used for this can for example be added in the form of chlorides to a solution containing the delaminated layered silicates. The relevant amounts or concentrations depend on the desired degree of prelamination or the desired degree of ion exchange. A person skilled in the art is capable of selecting and using the relevant amounts or concentrations of the aforementioned cations or salts thereof in the manner according to the invention.

The prelamination, including the number of layered silicate sheets to be joined together, can accordingly be controlled for example by means of the concentration of the divalent or trivalent cations described above, which instead of the original sodium or potassium cations can then perform the role of charge compensators, depending on the degree of cation exchange. The divalent or trivalent, function—without wishing to be restricted to this theory—as it were as coupling or bridging element, between two layered silicate sheets that are to be prelaminated, wherein the spacing of the layered silicate sheets is to be selected, within the scope of prelamination, so that subsequent introduction or incorporation or addition of the rare-earth complex is possible.

The method according to the invention is further characterized in that, already within the scope of prelamination, as described above, ions from the rare-earth group, preferably europium, can be introduced, or added between the layered silicate sheets, for example in the form of Eu cations using europium chloride. The ions from the rare-earth group used for the prelamination and introduced or added between the layered silicate sheets then serve as it were as nucleus (central atom) or starting point for subsequent introduction or addition or coupling with the ligands functioning as antennas, which will be discussed below. In this connection, it can also be envisaged according to the invention that the ion exchange is carried out with mixtures of the aforementioned cations, for example with magnesium cations and europium cations in a defined ratio, depending on the desired degree of loading.

Within the scope of the present invention, it has therefore proved advantageous for the cation exchange to be carried out either with magnesium cations and/or, if cations of the rare earths are already desirable at this stage in the interlayers bounded by the layered silicates, with ions of the rare earths (e.g. Sc³⁺, Y³⁺, and the f-elements from La³⁺ to Lu³⁺, preferably Eu³⁺), so that double layers and/or optionally even multiple layers form in a controlled way, and can then be further treated as described below.

In general, prelamination can be carried out with ions or cations with which a sandwich-like prelamination of the layered silicate sheets becomes possible, for the purpose of incorporating the luminescent dyes usable according to the invention.

Regarding the ion exchange that can be carried out within the scope of prelamination, the ion exchange can be 0.1 to 100%, in particular 1 to 80%, preferably 5 to 60%, and especially preferably 10 to 40%, relative to the exchangeable ions. In this respect, the exchange ions can be formed partially or completely by a rare-earth element.

Also regarding prelamination, according to another embodiment of the present invention, which can be carried out as an alternative to the cation exchange described above or to supplement the latter, before the step of introducing or incorporating or adding the rare-earth complex or formation of the rare-earth complex, at least one spacer (spacing molecule), preferably a large number of spacers, is introduced or incorporated or added between at least two layered silicate sheets. For this, in particular the use of an alkylammonium halide as spacer may be considered, and this can in particular be cetylammonium bromide (CPABr). In this way, a defined layer spacing of the layered silicate sheets can as it were be established within the scope of prelamination, so as to permit optimal incorporation or optimal introduction of she rare-earth complex between the layered silicate sheets. In this respect it is in particular notable that the spacing molecule should generally be constructed so that it has a preferably hydrophobic central molecular segment, which then generates a hydrophobic environment within the interlayer formed by the prelaminated layered silicate sheets, which is favorable for introduction of the rare-earth complex.

Regarding the incorporation of the spacer or spacing molecule, this can take place from solution, for which for example toluene can be used as solvent. Moreover, within the scope of prelamination, loading with the spacer or spacing molecule from the gas phase may also be considered, for which residual water or water of crystallization should be removed from the layered silicate sheets beforehand, for example by vacuum treatment. Methods that can be used for this are well known by a person skilled in the art, and require no further explanation.

The introduction or incorporation or addition of she luminescent dye, in particular of the rare-earth complex, can on the one hand take place according to the invention, so that at least one luminescent dye or at least one rare-earth complex is effected between the at least two layered silicate sheets in the form of the luminescent dye or rare-earth complex as such. In other words, as it were, previously prepared or complete luminescent dyes and therefore the finished rare-earth complex can be introduced or incorporated or added between the layered silicate sheets. A possible process step for production of the luminescent layered silicate composite according to the invention therefore comprises, first, carrying out the cation exchange as described above, and then loading the resultant prelaminated double layers or multilayers with complexes of the rare earths or rare-earth complexes. In this respect, the aforementioned rare-earth complexes may be considered. In particular, co-coordinated. β-diketonate complexes, such as Tris(1-(2-thenyl-4,4,4-trifluorobutane-1,3-dionato)(1,10-phenanthroline)Eu(III), generally also called Eu(ttfa)₃Phen, are suitable as previously prepared luminescent dye. The product resulting from incorporation of the aforementioned rare-earth complex can therefore generally—when using Laponites as layered silicate sheets be designated as [Eu(ttfa)₃]Lap. Moreover, analogous compounds may also be considered, such as on the basis of terbium(III), for example Tris(1,1,1,5,5,5-hexafluoropentane-2,4-dionato) (bis(2-methoxyethyl)etherato)Tb(III) or Tris-(1,1,1,5,5,5-hexafluoropentane-2,4-dionato)-(bis(2-methoxyethyl)-ether)Tb(III), also designated with the synonym Tb(hfa)₃diglyme, may be considered as rare-earth complex.

In the case of the previously prepared or complete luminescent dyes or rare-earth complexes described above, introduction or incorporation or addition of the at least one luminescent dye or rare-earth complex between the at least two layered silicate sheets can take place by gas phase loading and/or by liquid phase loading.

This can be carried out in a manner known per se by a person skilled in the art, in particular wherein, in the case of gas phase loading, residual water or water of crystallization can be removed beforehand, for example under vacuum, from the layered silicate sheets that are to be loaded and then they are mixed, for example under inert gas atmosphere, with a corresponding rare-earth complex. The mixture can for example be melted under vacuum, wherein by subsequent sublimation or gas-phase discharge, loading of the interspace, bounded by the prelaminated layered silicate sheets, with the luminescent dye can take place.

Gas-phase loading is in general not limited to the use of the luminescent central atoms in the form of Eu³⁺ or the rare earths, and the ligands for example are not limited to the aforementioned diketones or diketonates and aromatic carboxylic acids. Rather, all molecular compounds that can evaporate below their decomposition temperature or that can evaporate in vacuum below their decomposition temperature, can be used according to the invention, with which luminescence-activated layered silicate composites can be produced by incorporation in the interlayers.

On the other hand, loading with the fluorescent dye or rare-earth complex can be carried out by liquid-phase loading with a preferably soluble rare-earth complex or luminescent (lye. For Luis, prelaminated layered silicate sheets can be dispersed or dissolved in a solution of the luminescent dye or rare-earth complex, for example using toluene as solvent. The luminescent layered silicate composite according to the invention can be obtained by subsequent purification and extraction steps. With regard to the liquid phase in general, this can be aqueous, organic-aqueous or organic.

The liquid-phase loading is also in general not limited to the use of luminescent central atoms in the form of Eu³⁺ or the rare earths, just as the ligands for example are not limited to the aforementioned diketones or diketonates and aromatic carboxylic acids. Rather, according to the invention, all molecular compounds that are soluble in the loading phase can be used, with which luminescence-activated layered silicate composites can be produced by incorporation in the interlayers.

According to an alternative embodiment, carrying out in-situ generation of the luminescent dye or of the rare-earth complex between the at least two silicate layers can be envisaged within the scope of the method according to the invention.

The in-situ generation can be effected by, firstly, introducing or incorporating or adding the rare-earth element, in particular in ionic form, preferably in a preferably soluble and/or dispersible ionic compound, in particular within the scope of prelamination, between the at least two layered silicate sheets, in particular as described previously, and then the ligand or ligands forming the rare-earth complex with the rare-earth element is/are introduced and/or incorporated and/or added between the layered silicate sheets and brought in contact with the rare-earth element, with formation of the rare-earth complex.

According to this embodiment of the present invention, the production or final preparation or completion of the luminescent dye or of the luminescent rare-earth complex takes place in the interlayer bounded by the layered silicate sheets and therefore between the prelaminated layered silicate sheets per se. In particular, a possible procedure is that the introduction or addition of the ligands capable of interacting with the rare-earth element takes place via a liquid phase, in particular with the ligand or ligands being dissolved or dispersed beforehand in a solvent. As before, this can for example be an aqueous, aqueous-organic or organic solvent, for example toluene. In this connection, it is possible for example to use salts, for example sodium salts of the ligands that can be used, which were described above. A person skilled in the art is in each case capable of selecting the corresponding solvents and ligands and the corresponding ligand concentration against the background of the in-situ generation of the rare-earth complex.

Again with regard to the in-situ generation of the luminescent dye, the ligand or the ligands can, according to another embodiment of the present invention, also be introduced or incorporated or added via the as phase into the system or between the layered silicate sheets in order to generate the luminescent dye. In this case, for example a possible procedure is that residual water or water of crystallization is removed under vacuum from prelaminated layered silicates and they are then mixed, in an inert-gas atmosphere, with the ligands that are to be introduced or incorporated or added. Then the mixture can be melted under vacuum, with subsequent sublimation or gas phase discharge, so that the ligand or ligands is/are incorporated or introduced or added between the layered silicate sheets, to form a complex with the rare-earth element.

The in-situ generation of the luminescent dye is in general not limited to Eu³⁺ or to a rare-earth element and the stated ligands, but can be applied to all cations, with which a sandwich-like lamination (“double decker” etc.) of the layered silicate sheets is possible and which can be luminescence-activated by introduction or addition of suitable ligands (for example via the gas phase).

With regard to the introduction or incorporation or addition of the luminescent dye in general, the number of the luminescent dye (luminescent dye molecules or complexes) between two layered silicate sheets can be at least 1, in particular at least 10, preferably at least 50, more preferably at least 100, and especially preferably at least 200. At least 1 to 5000 luminescent dye molecules, in particular 10 to 4500 luminescent dye molecules, preferably 50 to 4000 luminescent dye molecules, more preferably 100 to 3000 luminescent dye molecules, and especially preferably 200 to 2000 luminescent dye molecules can be incorporated or introduced or added between two layered silicate sheets. The aforementioned values refer in particular to a layered silicate composite per se, preferably based on a “double decker” described above, i.e. based on an arrangement of two layered silicate sheets with luminescent dye introduced or incorporated or added between them.

This can be regarded as another decisive advantage of the present invention or of the method according to the invention, namely owing to the special procedure, a large number of luminescent dye molecules can be incorporated between two layered silicate sheets or the number of luminescent, dye molecules to be incorporated can be controlled or tailored, for example by means of the process parameters. As a result, luminescent layered silicate composites are obtained according to the invention, which owing to the presence of a large number or a defined amount of luminescent dye molecules, with correspondingly energetic excitation they have a strong emission signal and therefore as it were an intensification of the emission signal, which leads to high quantum yields even at low excitation intensity.

With regard to the luminescent layered silicate composite according to the invention, obtainable on the basis of the method according to the invention, this can luminesce, in particular fluoresce, in particular under the action of excitation energy and/or absorption of excitation energy. Moreover, the luminescent layered silicate composite can, in particular under the action of excitation energy or absorption of excitation energy, release detectable energy, in particular in the form of luminescence, preferably fluorescence, in particular wherein the released or emitted energy is of a form that can be differentiated or distinguished from the excitation energy, preferably the luminescence emission wavelength is of a form that can be differentiated or distinguished from the absorption wavelength of the excitation energy. In this connection, the luminescence, preferably fluorescence, should be in the visible range. For example, excitation can take place with Light of a wavelength below 400 nm, preferably in the UV range. Moreover, the energy released or emitted can be detected, preferably detected qualitatively and/or quantitatively, by means of a detecting device, in particular by means of a spectrometer. In addition, emission can take place in the visible range, making visual perception possible.

Within the scope of the method according to the invention it can be envisaged that the layered silicate composite, in particular at least one layered silicate sheet of the composite, is surface-modified. In particular, surface modification can be carried out on the side(s) of the layered silicate sheet opposite to the introduced and/or incorporated and/or added luminescent dye, in particular for the specific and/or nonspecific interaction and/or detection of a target structure, in particular a target molecule (“target”).

The surface modification can improve the compatibility of the laminar structure according to the invention, for example with respect to introduction or application and/or attachment on systems that are to be marked, such as glass or plastics. In addition, increased affinity or specificity with respect to the interaction or labeling of biological systems can be created deliberately.

Surface modification of the at least one layered silicate sheet of the luminescent layered silicate composite according to the invention can be carried out before or after formation of the layered silicate composite according to the invention. As a result of the surface modification, the luminescent layered silicate composite according to the invention can be modified so that it is able to interact with the target structure, in particular with the target, or this interaction is optimized. This can be both a specific and a nonspecific interaction.

Against this background, for the surface modification of the layered silicate composite according to the invention, chemical or functional groups can be introduced or applied on the surface of the layered silicate composite or the layered silicate sheets in a manner known by a person skilled in the art. These functional groups can be selected, for example and non exhaustively, from carboxyl, carbonyl, thiol, amino and/or hydroxyl groups. Carboxylate, isocyanate, thioisocyanate or epoxy groups may also be considered. Biological, molecules can also be used for surface modification. In this respect, for example polypeptides or protein structures can be applied on the surface, which can for example interact in the manner of a ligand with for example a receptor of the target structure or of the biological system. A modification with nucleic acids or the like may also be considered within the scope of the present invention.

With regard to the target structure or the target molecule, this can be, non-exhaustively, polymers or biopolymers, biomolecules, in particular proteins, peptides, antibodies, nucleic acids, but also noncellular systems, such as bacteria, viruses, phage or the like.

The target structure or the target molecule can also be polymer systems in the manner of plastics or the like, which can as it were be labeled or marked with the luminescent layered silicate composite. The systems to be marked can, non-exhaustively, also be glass or the like. In this respect, the laminar structure according to the invention can be applied or introduced or added to the object to be marked, for example within the scope of a dispersion. Altogether, objects in general, and made of various materials, such as wood, metal, paper, fabric, may be considered for marking with the laminar structure according to the invention. For this, the laminar structure according no the invention can for example be applied on the surface of the object, for example within the scope of a dispersion of adhesive or the like.

Fibers, textiles and/or paper can also serve as target structure or target molecules. The fibers and textiles can for example be formed in each case on the basis of biopolymers or natural raw materials and/or synthetic or chemical biopolymers. In particular the fibers and textiles can be formed on the basis of cotton or wood pulp, or on the basis of cellulose, starch, cellulose/lignin or polysaccharide/lignin composites, chitosan or the like.

The interaction with the target structure or the target molecule can for example also take place via coordinate or covalent, preferably coordinate bonds, with the luminescent layered silicate composite according to the invention, in particular with the relevant functional groups that were applied. Binding of she layered silicate composite according to the invention can for example take place via at least one functional group of the target structure.

In this connection, the interaction between luminescent layered silicate composite on the one hand and target structure or target on the other hand can take place with formation of a conjugate of target structure or target, such as a biomolecule, on the one hand and layered silicate composite on the other hand, to form a layered silicate composite/target structure conjugate.

Also within the scope of the labeling of biological systems, for example biological cells or the like, the luminescent layered silicate composite according to the invention can be incorporated, for example by endocytosis, into the cellular system. In this way, effective labeling of target structures becomes possible, in particular as there can also be accumulation of luminescent layered silicate composites in the target system. In this respect it is also notable that—as already mentioned—the luminescent layered silicate composite according to the invention has greatly intensified emission properties and moreover has good biocompatibility and dimensional optimization with respect to incorporation, in particular by means of endocytosis, into cellular systems.

The labeling or identification of the target structure can therefore take place on the basis of the luminescence properties of the luminescent layered silicate composite according to the invention. The reaction product from target structure on the one hand and luminescent layered silicate composite on the other hand can luminesce or fluoresce under the action of excitation energy or absorption of excitation energy.

Moreover, based on the luminescent layered silicate composite obtainable by the method according to the invention, effective and efficient marking of objects, for example based on plastics, can be carried out, for example by introducing or dispersing the luminescent layered silicate composite in a plastic. Surface application of the luminescent layered silicate composite according to the invention on corresponding objects is also easily possible, so that this also provides a simple and reliable possibility for identification of the object marked with the luminescent layered silicate composite according to she invention.

A further object of the present invention—according to a second aspect of the present invention—is the luminescent, layered silicate composite, which can be obtained by the method according to the invention, in particular as described above.

The present invention further relates—according to a third aspect of the present invention—to a luminescent layered silicate composite per se. The luminescent layered silicate composite according to the invention is characterized in that the layered silicate composite comprises at least one luminescent dye, in particular fluorescent dye, based on at least one complex, in particular chelate complex, of at least one rare-earth element (“rare-earth complex”), wherein the luminescent dye is introduced and/or incorporated between at least two layers in each case of at least one layered silicate (“layered silicate sheets”). Furthermore, the luminescent layered silicate composite according to the invention can be characterized in that it comprises at least one luminescent dye, in particular fluorescent dye, based on at least one complex, in particular chelate complex, of at least one rare-earth element (“rare-earth complex”), wherein the at least one luminescent, dye, in particular fluorescent dye, based on at least one complex, in particular chelate complex, of at least one rare-earth element (“rare-earth complex”) is made into a composite with a layered silicate, in particular wherein the luminescent dye is introduced and/or incorporated in and/or between at least two layers of in each case at least one layered silicate (“layered silicate sheets”) and/or is added to at least two layers in each case of at least one layered silicate (“layered silicate sheets”).

In this respect, reference may be made to the above account of the method according to the invention for production of the luminescent layered silicate composite according to the invention.

The present invention further relates—according to a fourth aspect of the present invention—to a solution and/or dispersion, which contains at least one luminescent laminar structure, in particular as defined above.

In this connection, the solution or dispersion according to the invention can as it were be ready for use or application for the purposes of marking or identification of the aforementioned target structures. The luminescent layered silicate composites according to the invention can, for the purposes of production of the solution or dispersion according to the invention, be dissolved or dispersed in an aqueous, aqueous-organic or organic solvent.

The present invention further relates—according to a fifth aspect of the present invention—to the use of at least one luminescent layered silicate composite, in particular as defined above, for staining, in particular luminescent staining, for labeling and/or for identification of at least one target structure, in particular a target molecule.

The term “staining”, as it can be understood in the context of the present invention, means in particular that a target structure or a substrate, after application of the luminescent dye or of the luminescent, layered silicate composite functioning as marking system, is able to deliver an optical response that can be differentiated and/or detected and/or evaluated or a corresponding signal to an in particular electromagnetic excitation stimulus. If she optical response that can be differentiated and/or detected and/or evaluated or a corresponding signal to an in particular electromagnetic excitation stimulus is employed for the differentiation of several substrates or for quantification, e.g. by evaluating incremental changes of intensity or wavelength (e.g. as a function of the amount of substance, temperature, nature of the substrate etc.), then it is in particular a labeling in the sense of the present invention and not a mere staining, and in such a case the luminescent layered silicate composite according to the invention can also be used as sensor.

The present invention further relates—according to a sixth aspect of the present invention—to the use of at least one luminescent layered silicate composite according to the invention, in particular as defined above, for the luminescent, labeling or identification, in particular fluorescence labeling or identification, of at least one target structure, in particular at least one target molecule.

Furthermore, the present invention relates—according to a seventh aspect of the present invention—to a method for labeling or identifying at least one target structure, in particular at least one target molecule, which is characterized in that the target structure, in particular the target molecule, is brought in contact with at least one layered silicate composite, in particular as defined above, and in particular is made to interact, preferably to react, preferably with formation of a bond, in particular coordinate and/or covalent bond, preferably coordinate bond, between biomolecule on the one hand and layered silicate composite on the other hand.

With regard to the uses according to the fifth and sixth aspect and the method according to the seventh aspect of the present invention, the target structure, in particular the target molecule, can be selected from the group comprising plastics, metals, glass, wood, textiles, paper or the like. The target structure, in particular the target molecule, can however also be selected from the group comprising biomolecules, in particular proteins, peptides, antibodies and/or nucleic acids and cellular systems, such as multicellular or unicellular systems, such as bacteria or the like. Labeling of viruses or phage may also be considered in the context of the present invention.

On the whole, the present invention is not limited to a method of identifying or labeling a target molecule, with development of a specific interaction. Rather the present invention also comprises, methods for labeling or identifying a target structure, by which at least one luminescent layered silicate composite according to the invention, preferably a large number of luminescent layered silicate composites according to the invention, is introduced or incorporated into a target structure or is added thereto, for example in the manner of mixing or incorporation or application in the form of a label, so as to permit identification or authentication or marking of the corresponding object.

In this connection, the luminescent layered silicate composite according to the invention can for example be introduced in the manner of a dispersion into a plastic, which for example undergoes subsequent curing or the like.

The present invention further relates—according to an eighth aspect of the present invention—to a layered silicate composite/target molecule conjugate or a layered silicate composite/target structure conjugate, which can be obtained by contacting and/or reaction, in particular reaction, of at least one target structure or target molecule on the one hand and at least one layered silicate composite according to the invention, in particular as defined above, on the other hand.

Moreover, the present invention also relates to layered silicate composite/target structure mixture or a layered silicate composite/target molecule mixture, which is formed by contacting and/or introduction and/or incorporation of at least one layered silicate composite according to the invention, in particular as defined above, in a mass containing or consisting of the target molecule or the target structure.

The present invention, in particular the luminescent layered silicate composite according to the invention, is associated with a large number of other advantages, which are summarized below.
The luminescent layered silicate composite according to the invention has an optimal emission behavior, in particular emission spectrum, in particular with narrow line emissions, which are advantageous, for the use of optical filters, and a large Stokes shift, which is advantageous for the use of optical filters and in particular for the spectral separation of the excitation light. Moreover, the excited states have long lifetimes, in the millisecond range, and therefore provide fluorescence signals that are longer by a factor of up to 1000 than organic fluorophors and quantum dots; as a result there is excellent discrimination with respect to autofluorescence and other interfering signals in the temporal regime. With regard to the excellent emission properties, reference may be made in particular to FIG. 6 and FIG. 7.
Furthermore, the luminescent layered silicate composites according to the invention have practically no toxicity, in particular of the matrix, which is a considerable advantage, for example with respect to applications in biological systems. Rather, the luminescent layered silicate composites according to the invention even have very good biocompatibility and can in particular be incorporated by biological cells, phage and cells of the immune system, in particular within the scope of endocytosis. This can be regarded as a decisive advantage relative to so-called quantum dots, which often have appreciable toxicity.
The luminescent layered silicate composites according to the invention have an optimized dimensioning or size, so that in particular they are exactly in the optimal size regime with respect to endocytosis.
In addition, the luminescent layered silicate composites according to the invention have good water solubility, so that they are eminently suitable for the labeling or identification of biological systems. Moreover, nonturbid or nonscattering solutions can be produced, which is advantageous in particular with respect to the detection of measurement signals.
The layered silicates or layered silicate sheets used within the scope of the present invention have optimal surface chemistry, permitting adaptation to various solvents or environments, as well as specific, in particular biological functionalizations even with biomolecules, for example monoclonal antibodies in particular. Furthermore, specific functionalizations can be achieved for biomolecules by providing the surface of the layered silicates used, for example with active groups for coupling to biomolecules or to proteins.
Furthermore, the luminescent layered silicate composites according to the invention have the possibility of intermolecular energy transfer within the individual layered silicate composites, so that so-called multicolor assays are also possible. In this respect it is also of relevance that FRET-based fluorescent dyes can be introduced or incorporated or added in the system according to the invention.
The luminescent layered silicate composites according to the invention also have increased chemical stability, in particular photostability, which can be attributed for example to the embedding of the luminescent dye in the matrix. This results for example in reduced photobleaching, as well as greater stability in various environments or solvents or media.
Finally, the method according to the invention is a cost-effective method of production of the luminescent layered silicate composites, in which sometimes even standard chemicals, such as the delaminated layered silicates already described, can be used.

Further embodiments, modifications and variations of the present invention can readily be recognized and implemented by a person skilled in the art on reading the description, while remaining within the scope of the present invention.

The present invention will be illustrated by the following examples, which do not, however, limit the present invention in any way.

### Examples

For the methods described below, Laponite® RD (powder from Rockwood Specialties Group, Inc., Princeton, N.J., USA) with the composition Na_{0.7}Li_{0.3}Mg_{5.5}Si₈O₂₀(OH)₄ and with a stated particle diameter of 30 nm can be used as the layered silicate forming the layered silicate sheets.

### 1. Prelamination:

By partial cation exchange (prelamination), delaminated layered silicates can be made to form two-layer and multilayer, sandwich-like sheet or layered structures or arrangements (“double decker”, “triple decker”, “tetradecker” etc.), in which luminescent species can be incorporated between the layers.

This prelamination can be controlled by means of the concentration of divalent or trivalent ions, which then assume the role of charge compensators instead of the original sodium atoms, depending on the degree of cation exchange. According to the invention, it has proved advantageous to perform the cation exchange either with Me or, if rare-earth ions are already desirable in the interlayers at this stage, with Ln³⁺ ions (Sc³⁺, Y³⁺ and the f-elements from La³⁺ to Lu³⁺), so that controlled prelaminated double layers and optionally also multiple layers are formed, which can then be treated further, by various methods, as described below.

### Prelamination of the Samples:

2 g of Laponite® RD is dispersed in 98 ml of an aqueous solution, in which a predetermined amount of M²⁺ or M³⁺ is dissolved, which makes the desired degree of cation exchange possible. M²⁺ or M³⁺ are any divalent or trivalent ions, preferably Mg²⁺, Y³⁺ and Eu³⁺ and/or Tb³⁺, if the prelaminated Laponite already contains luminescence-active ions, as is required for example in the Method A given below. In the examples, Eu³⁺ and Mg²⁺ are used in the form of the respective chlorides. The degree of cation exchange can be 0.1 to 100%, and in the examples presented here it is adjusted to 20% Eu³⁺ ([Eu(ttfa)₃]Lap, Method A below) and 10% Mg²⁺ ([Eu(ttfa)₃phen]LapGP, method B below and [Eu(ttfa)₃phen]LapLP, method C below). The Laponite dispersion is then stirred at room temperature for 10 h. The resultant transparent, viscous dispersion is carefully dewatered in the rotary evaporator, forming a transparent film. The product is washed with ethanol several times, to wash away any NaCl that formed, and is dried at 90° C. and 20 mbar.

### 2. Method A: Introduction or Incorporation or Addition of the Luminescent Dye by In-Situ Generation of the Rare-Earth Complex by Ligand-Gas Phase Loading

In this method, prelaminated Laponite® RD is loaded, via the gas phase, with organic ligands that are known to form luminescent complexes, e.g. with the rare earths; a number of βdiketones, such as 2-Thenyl-4,4,4-trifluorobutane-1,3-dion, “Httfa”, as well as aromatic carboxylic acids and derivatives thereof, for example benzoic acid, pyridine carboxylic acid, bipyridine dicarboxylic acid or cinnamic acid, are especially suitable, e.g. for Eu³⁺. After loading, excess ligand can be removed by extraction. The product of this procedure can be designated as “[Eu(ttfa)₃]Lap” (Lap=Laponite). Analogous compounds of Tb³⁺, e.g. Tris(1,1,1,5,5,5-hexafluoropentane-2,4-dioanato)Tb(III), can be obtained by a comparable procedure.

The method is in general not limited to Eu³⁺ and the stated ligands, but can be applied to all cations with which a sandwich-like lamination (“double decker” etc., cf. The account given above) of the layered silicate sheets is possible and which can be luminescence-activated by the introduction or addition of suitable ligands (for example via the gas phase).

The species or rare-earth complexes that are finally formed in the interlayers bounded by the layered silicate sheets can be of molecular, polymeric or nanoparticulate character.

Method. Production of [Eu(ttfa)₃]Lap:

1 g of Laponite® RD prelaminated with 20% Eu³⁺ is treated in vacuum (0.02 mbar), so that included and attached water of crystallization is largely removed, mixed under argon with a corresponding amount of the Httfa ligand (Eu³⁺:Httfa=1:3), e.g. 43.3 mg for 1 g Eu³⁺-Laponite® RD. The mixture is then melted in a glass ampule under high vacuum (5·10⁻⁵ mbar). The subsequent sublimation (gas phase loading) is carried out at 50° C. within 24 h, Inc product obtained after opening and aerating the ampule is gently rehydrated by exposure to the ambient air for 48 h Excess, uncomplexed ligand is extracted with pentane several, times and the resultant purified product is dried at 50° C. in a drying cabinet. Analogous compounds of Tb³⁺ can be obtained by a comparable procedure (e.g. Tris(1,1,1,5,5,5-hexafluoropentane-2,4-dioanato)Tb(III)).

### 3. Method B: Introduction or Incorporation or Addition of the Complete Luminescent Dye by Rare-Earth Complex Gas Phase Loading

Another method is to carry out the cation exchange as described and then load the double or multiple arrangements of the layered silicate sheets with volatile complexes of rare earths via the gas phase. Examples of this are in particular co-coordinated β-diketonate complexes, a typical example of which is in particular Tris(1-(2-thenyl)-4,4,4-trifluorobutane-1,3-dionato) (1,10-phenanthroline)Eu(III), also called “Eu(ttfa)Phen”. The product from this procedure can be designated as “[Eu(ttfa)₃]Lap” (Lap=Laponite). Analogous compounds of Tb³⁺, e.g. Tris(1,1,1,5,5,5-hexafluoropentane-2,4-dioanato) (bis (2-methoxyethyl)ether)Tb(III), also “Tb(hfa)₃diglyme”, can be obtained by a comparable procedure.

The use of the luminescent central atoms is therefore once again generally not limited to Eu³⁺ or the rare earths, just as the ligands for example are not limited to the stated diketones or diketonates and aromatic carboxylic acids, but rather all molecular compounds that evaporate below their decomposition temperature or that evaporate in vacuum below their decomposition temperature car be used, with which luminescence-activated layered silicate composites can be obtained by incorporation in the interlayers. The products of this method can be designated as “[Eu(ttfa)₃phen]LapGP” (GP=gas phase), but they include all luminescent species of a molecular, polymeric or nanoparticulate character that are obtained by this method.

Method B; Production of [Eu(ttfa)₃Phen]LaPCP by Gas Phase Loading with Sublimable Eu(ttfa)₃Phen:

Eu(ttfa)₃Phen is introduced by sublimation into the interlayers of the prelaminated layered silicate as follows:

1 g of the Laponite prelaminated with 10% Mg²⁺ is treated in vacuum (0.02 mbar) so that included and attached water of crystallization is largely removed, mixed under argon with 200 mg Eu.ttfa)₃Phen and then melted in a glass ampule under high vacuum (5·10⁻⁵ mbar). Sublimation is carried out at 150 to 160° C. within 10 to 12 h. After opening the ampule, excess complex is extracted from the product with toluene (Soxhlet) until the eluate is complex-free (absence of luminescence), and then the product is dried at 50 to 100° C. in a drying cabinet. Analogous compounds of Tb³⁺ can be obtained by a comparable procedure (e.g. Tris(1,1,1,5,5,5-hexafluoropentane-2,4-dioanato)Tb(III)).

### 4. Method c: Introduction or Incorporation or Addition of the Complete Luminescent Dye by Rare-Earth Complex Liquid-Phase Loading

Another method is to carry out the cation exchange as previously in aqueous solution and then load the double or multiple arrangements of the layered silicate sheets with soluble complexes of the rare earths via the liquid phase (“loading phase”), wherein the second step also includes nonaqueous solutions, e.g. based on DMF or toluene. In general, all dye complexes that are soluble in the loading phase are suitable for the method. In this respect, we may mention for example complexes of the are earths with Eu as emitter ion and Httfa in combination with phenanthroline (cf. account given above), which have sufficient solubility e.g. in DMF or toluene. Similarly, for example Tris(1,1,1,5,5,5-hexafluoropentane-2,4-dioanato)(bis(2-methoxyethyl)ether)Tb(III), “Tb(hfa) diglyme”, can also be used here. The resultant products can be designated as “[Eu(ttfa)₃phen]LapFP” (FP=liquid phase), but once again include all luminescent species of a molecular, polymeric or nanoparticulate character obtained in this way.

Method. C. Production of [Eu(ttfa)₃phen]LapLP by Liquid-Phase Loading with Soluble Eu(ttfa)₃phen:

1 g of the Laponite prelaminated as above with 10% Mg²⁺ is dispersed in 100 ml of 1·10⁻³ M Eu(ttfa)₃Phen solution in toluene and boiled under reflux for 3 to 8 h, then filtered and dried. The mother liquor that remains is checked for presence of the complex (UV lamp). If positive, the powder is extracted with toluene (Soxhlet) until luminescent eluate ceases to be obtained from the pulverulent product, and then it is dried at 50 to 100° C. in a drying cabinet.

The activated layered silicates with incorporated luminescent complexes of the rare earths obtainable on the basis of the methods presented above, or other luminescent compounds, can generally be surface-modified by known methods, e.g. for dispersion in polymers, attachment to solid substrates (glass surfaces) and biologically relevant macromolecules, e.g. proteins and antibodies or cellular substrates.

For example, layered silicates luminescence-functionalized with Eu³⁺ and 1-(2-Thenyl)-4,4,4-trifluorobutane-1,3-dione and with Eu³⁺ and 1-(2-Thenyl)-4,4,4-trifluorobutane-1,3-dione and phenanthroline have characteristic emission spectra (FIG. 7b) and FIG. 7d)), which are compared in FIG. 7 with the respective pure complexes (FIG. 7a) and FIG. 7c)).

1-60. (canceled)

61. A method for producing a luminescent layered silicate composite,
wherein at least one fluorescent dye based on at least one chelate complex of at least one rare-earth element (rare-earth complex) is introduced or incorporated between at least two layers of in each case at least one layered silicate (layered silicate sheets); and/or
wherein at least one fluorescent dye based on at least one chelate complex of at least one rare-earth element (rare-earth complex) is made into a composite with a layered silicate, wherein the fluorescent dye is introduced or incorporated in or between at least two layers of in each case at least one layered silicate Or is added to at least two layers of in each case at least one layered silicate (layered silicate sheets).

62. The method as claimed in claim 61, wherein the layered silicate forming the layered silicate sheets is used in the form of discrete bodies with defined dimensions.

63. The method as claimed in claim 61, wherein the layered silicate sheets, independently of one another, have in all dimensional directions a size of at most 100 nm.

64. The method as claimed in claim 61, wherein the layered silicate sheets, independently of one another, are formed at least essentially flat.

65. The method as claimed in claim 61, wherein the layered silicate sheets are water-dispersible or water-soluble.

66. The method as claimed in claim 61, wherein a layered silicate containing or consisting, of tetrahedral or octahedral layers is used as the layered silicate forming the layered silicate sheets, wherein the tetrahedral layer contains SiO₄ units and the octahedral layer contains Mg(OH)₂ units or Al(OH)₃ units.

67. The method as claimed in claim 61, wherein the layered silicate forming the layered silicate sheets is selected from the group comprising magnesium silicates, magnesium-lithium silicates, magnesium-aluminum silicates, aluminum silicates and iron-aluminum silicates.

68. The method as claimed in claim 61, wherein the layered silicate forming the layered silicate sheets is selected from the group comprising beidellite, montmorillonite, nontronite, saponite and hectorite.

69. The method as claimed in claim 61, wherein a layered silicate with the general formula
(M⁺)ₓ[(Si₈Me_{5.5}M′_{0.3})O₂₀(OH)₄]^{x-}
is used as the layered silicate forming the layered silicate sheets,
wherein M is selected from the group of lithium, sodium, potassium, rubidium,
wherein M′ is selected from the group of lithium, sodium, potassium, rubidium,
wherein Me is selected from the group of alkaline-earth metals and aluminum, and
wherein x is a rational number in the range from 0.1 to 1.

70. The method as claimed in claim 61, wherein a layered silicate with the general formula
(M⁺)_{x′}[Si₈Me_{5.5}M′_{0.3})O₂₀(OH)_{2.5}F_{1.5}]^{x′-}
is used as the layered silicate forming the layered silicate sheets,
wherein M is selected from the group of lithium, sodium, potassium, rubidium,
wherein M′ is selected from the group of lithium, sodium, potassium, rubidium,
wherein Me is selected from the group of alkaline-earth metals and aluminum, and
wherein x is a rational number between 0.1 and 1.

71. The method as claimed in claim 61, wherein the at least two layered silicate sheets are arranged at least essentially plane-parallel or sandwich-like one above the other, wherein the fluorescent dye is introduced or incorporated or added between these at least two layered silicate sheets.

72. The method as claimed in claim 61, wherein the fluorescent dye is made to interact with at least one of the at least two layered silicate sheets.

73. The method as claimed in claim 61, wherein at least one further layered silicate sheet, identical or different, is arranged or applied on at least one of the at least two layered silicate sheets on the side opposite to where the fluorescent dye is introduced or incorporated or added, wherein the fluorescent dye is introduced or incorporated or added between the at least one further layered silicate sheet and the layered silicate sheet(s) opposite thereto.

74. The method as claimed in claim 61, wherein the rare-earth element is selected from europium and terbium.

75. The method as claimed in claim 61, wherein the rare-earth complex has at least one organic coordinate-bound ligand based on β-diketone or wherein the rare-earth complex has at least one ligand based on picolinic acid, picolinates or derivatives thereof.

76. The method as claimed in claim 61, wherein the fluorescent dye is selected from a compound of the general formula
[Lnᵤ(Pic)_{y}(Pic-Y)_{z}]^{(4-3u)-},
wherein in the above formula
Ln is a rare-earth element in the form of europium(III) or terbium(III),
Pic is picolinate,
Y a functional group selected from the group of amino, carboxylate, isocyanate, thioisocyanate, epoxy, thiol and hydroxyl groups,
u is an integer from 1 to 4, and
y and z are in each case an integer from 0 to 4 with y+z=4.

77. The method as claimed in claim 61, wherein two mutually different rare-earth complexes are used as fluorescent dye(s), wherein the first rare-earth complex contains, as rare-earth element, europium and the second rare-earth complex contains, as rare-earth element, terbium.

78. The method as claimed in claim 61, wherein before the step of introducing or incorporating or adding the rare-earth complex, at least one spacer (spacing molecule) is introduced or incorporated or added between at least two layered silicate sheets.

79. A luminescent layered silicate composite,
wherein the layered silicate composite comprises at least one fluorescent dye based on at least one chelate complex of at least one rare-earth element (“rare-earth complex”), wherein the fluorescent dye is introduced or incorporated between at least two layers in each case of at least one layered silicate (“layered silicate sheets”), and/or
wherein the layered silicate composite comprises at least one fluorescent dye based on at least chelate complex of at least one rare-earth element (“rare-earth complex”), wherein the at least one fluorescent dye based on at least one chelate complex of at least one rare-earth element (“rare-earth complex”) is made into a composite with a layered silicate, wherein the fluorescent dye is introduced or incorporated in or between at least two layers of in each case at least one layered silicate (“layered silicate sheets”) or is added to at least two layers of in each case at least one layered silicate (“layered silicate sheets”).

80. A layered silicate composite/target structure conjugate, Obtainable by contacting or reacting of at least one target molecule on the one hand and at least one layered silicate composite, on the other hand,
wherein the layered silicate composite comprises at least one fluorescent dye based on at least one chelate complex of at least one rare-earth element (“rare-earth complex”), wherein the fluorescent dye is introduced or incorporated between at least two layers in each case of at least one layered silicate (“layered silicate sheets”), and/or
wherein the layered silicate composite comprises at least one fluorescent dye based on at least chelate complex of at least one rare-earth element (“rare-earth complex”), wherein the at least one fluorescent dye based on at least one chelate complex of at least one rare-earth element (“rare-earth complex”) is made into a composite with a layered silicate, wherein the fluorescent dye is introduced or incorporated in or between at least two layers of in each case at least one layered silicate (“layered silicate sheets”) or is added to at least two layers of in each case at least one layered silicate (“layered silicate sheets”).
